(19) United States
(12) Patent Application Publication
(10) Pub. No.: US 2013/0278649 A1
(43) Pub. Date: Oct. 24, 2013

(54) DRIVING METHOD FOR PLASMA DISPLAY PANEL, AND PLASMA DISPLAY DEVICE

(71) Applicants: Ayuhiko Saito, Osaka (JP); Takahiko Origuchi, Osaka (JP); Yuya Shiozaki, Osaka (JP); Naoyuki Tomioka, Osaka (JP); Hidehiko Shoji, Osaka (JP)

(72) Inventors: Ayuhiko Saito, Osaka (JP); Takahiko Origuchi, Osaka (JP); Yuya Shiozaki, Osaka (JP); Naoyuki Tomioka, Osaka (JP); Hidehiko Shoji, Osaka (JP)

(73) Assignee: PANASONIC CORPORATION, Osaka (JP)

(21) Appl. No.: 13/995,011

(22) PCT Filed: Dec. 22, 2011
(86) PCT No.: PCT/JP2011/007189

§ 371 Date: Jun. 17, 2013

(30) Foreign Application Priority Data
Dec. 27, 2010 (JP) 2010-289370

(51) Int. Cl. G09G 3/28

(52) U.S. Cl. CPC G09G 3/28
USPC 345/690; 345/72

(57) ABSTRACT

In the plasma display apparatus, address discharge is caused stably. For this purpose, one of a forced initializing operation and a selective initializing operation is performed in the initializing period. Then, one field includes a specific-cell initializing subfield having an initializing period in which a forced initializing operation is performed in a specific discharge cell and a selective initializing operation is performed in the other discharge cells. In the address period of the specific-cell initializing subfield, the period in which a scan pulse and an address pulse are simultaneously applied to a discharge cell having undergone the selective initializing operation in the initializing period of the specific-cell initializing subfield is made longer than the period in which a scan pulse and an address pulse are simultaneously applied to a discharge cell having undergone the forced initializing operation in the initializing period of the specific-cell initializing subfield.

### TECHNICAL FIELD

The present invention relates to a driving method of a plasma display panel of an image display apparatus using an alternating-current surface discharge type plasma display panel, and relates to a plasma display apparatus.

### BACKGROUND ART

An alternating-current surface discharge type panel typical as a plasma display panel (hereinafter referred to as “panel”) has many discharge cells between a front substrate and a rear substrate that are faced to each other. The front substrate has the following elements:
a plurality of display electrode pairs disposed in parallel on a front glass substrate; and
a dielectric layer and protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure ratio of 5%, for example, is filled into a discharge space in the sealed product. Discharge cells are disposed in the intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing operation of applying an initializing waveform to each scan electrode and causing initializing discharge in each discharge cell is performed. Thus, wall charge required for a subsequent address operation is produced in each discharge cell, and a priming particle (an excitation particle for causing discharge) for stably causing address discharge is generated.

The initializing operation includes a forced initializing operation and a selective initializing operation. In the forced initializing operation, initializing discharge is forcibly caused in a discharge cell regardless of the operation of the immediately preceding subfield. In the selective initializing operation, initializing discharge is selectively caused only in the discharge cell having undergone address discharge in the address period in the immediately preceding subfield.

In the address period, scan pulses are sequentially applied to scan electrodes, and address pulses are selectively applied to data electrodes based on an image signal to be displayed. Thus, address discharge is caused between the scan electrode and the data electrode of the discharge cell to emit light, thereby producing wall charge in the discharge cell (hereinafter, this operation is also collectively referred to as “address”).

In a sustain period, as many sustain pulses as a number based on the luminance weight determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Light is thus emitted in each discharge cell at a luminance corresponding to the luminance weight. Thus, light is emitted at a luminance corresponding to the gradation value of an image signal in each discharge cell of the panel, and an image is displayed on the image display region of the panel.

Light emission of a phosphor layer by sustain discharge is related to gradation display. Light emission caused by the forced initializing operation in the initializing period is not related to gradation display.

One of important factors of improving the quality of an image to be displayed on the panel is to sharpen the contrast. As one of driving methods of the panel by the subfield method, a driving method of minimizing the light emission related to no gradation display and sharpening the contrast of the image to be displayed on the panel is disclosed (for example, Patent Literature 1).

In this driving method, a forced initializing operation of causing initializing discharge in all discharge cells in the initializing period of one subfield, of a plurality of subfields constituting one field, is performed. A selective initializing operation is performed in the initializing periods of the other subfields.

When a forced initializing operation is performed, ramp waveform voltage having a gentle ramp part where voltage gradually increases and a gentle ramp part where voltage gradually decreases is applied to the scan electrodes. This prevents the phenomenon where strong discharge occurs in a discharge cell to cause strong light emission during the forced initializing operation.

The luminance (hereinafter referred to as “luminance of black level”) in a black displaying region that does not cause sustain discharge depends on the light emission caused regardless of the magnitude of the gradation value. This light emission is caused by the forced initializing operation, for example.

In the driving method disclosed in Patent Literature 1, the forced initializing operation is performed once per field, and the light emission in the black displaying region is only feeble light emission when the forced initializing operation is performed. Thus, comparing with the case where the forced initializing operation is performed in all discharge cells in each subfield, the luminance of black level of the image displayed on the panel can be reduced and an image of high contrast can be displayed on the panel.

Further, a driving method is disclosed where display electrode pairs are divided into n parts, and the number of forced initializing operations is set at one for n fields, thereby further reducing the light emission related to no gradation display, further reducing the luminance of black level, and further sharpening the contrast (for example, Patent Literature 2).

In the driving method disclosed in Patent Literature 2, the number of forced initializing operations per unit time (e.g. one second) can be reduced and the luminance of black level can be reduced comparing with the driving method disclosed in Patent Literature 1.

However, the forced initializing operation has a function of accumulating, in a discharge cell, wall charge required for causing address discharge in the subsequent address period. In addition, the forced initializing operation has a function of generating priming particles for shortening the discharge delay time to certainly cause the address discharge. This discharge delay time means the time required after the voltage applied to the discharge cell exceeds a discharge start voltage until discharge actually occurs. As the discharge delay time increases, the occurrence of the discharge becomes unstable.

When the occurrence frequency of the forced initializing operation is reduced, the wall charge and the number of priming particles required for causing the address discharge become insufficient, the discharge delay time of address discharge increases, the address operation becomes unstable, or malfunction such as no occurrence of the address discharge can occur. Especially, sustain discharge does not occur in the discharge cell to display black, so that the number of priming particles is apt to become insufficient and the address operation is apt to become unstable. When the address operation becomes unstable and sustain discharge does not occur in the discharge to emit light, a normal image cannot be displayed on the panel.

Recently, as the screen of the panel is enlarged and the definition thereof is enhanced, it is desired that the image display quality is further improved.

### CITATION LIST

Patent Literature
PTL 1 Unexamined Japanese Patent Publication No. 2000-242224
PTL 2 Unexamined Japanese Patent Publication No. 2006-091295

### SUMMARY OF THE INVENTION

In a driving method for a panel of the present invention, gradation is displayed on the panel having a plurality of discharge cells having a data electrode and a display electrode pair formed of a scan electrode and sustain electrode by setting, in one field, a plurality of subfields having an initializing period, an address period, and a sustain period. In this driving method, one of the following operations is performed in the initializing period:
a forced initializing operation of causing initializing discharge in a discharge cell: and
a selective initializing operation of selectively causing initializing discharge in the discharge cell having undergone address discharge in the immediately preceding subfield.
   One field includes the following subfields:
a specific-cell initializing subfield having an initializing period in which the forced initializing operation is performed in a specific discharge cell and the selective initializing operation is performed in the other discharge cells; and
a selective initializing subfield having an initializing period in which the selective initializing operation is performed in all discharge cells.
   Then, in the address period of the specific-cell initializing subfield, the period in which a scan pulse and an address pulse are simultaneously applied to a discharge cell having undergone the selective initializing operation in the initializing period of the specific-cell initializing subfield is made longer than that to a discharge cell having undergone the forced initializing operation in the initializing period of the specific-cell initializing subfield.

Thus, the contrast of an image displayed on the panel is sharpened, address discharge is caused stably, and hence the image display quality of a plasma display apparatus can be improved.

In this driving method, the following process may be employed. One field group is constituted by a plurality of temporally continuous fields, and one scan electrode group is constituted by a plurality of sequentially disposed scan electrodes. A forced initializing waveform for a forced initializing operation is applied to each of the scan electrodes constituting the scan electrode group only in one field of one field group. In the address period of the specific-cell initializing subfield, the period in which a scan pulse and an address pulse are simultaneously applied to a discharge cell is made longer in a subfield temporally more away from the initializing period having undergone the forced initializing operation.

In this driving method, the following process may be also employed. The pulse width of the address pulse is set to be equivalent to or greater than that of the scan pulse in the address period. Regarding a discharge cell to cause address discharge, the address pulse is also applied to the discharge cell while the scan pulse is applied to the discharge cell. In the address period of the specific-cell initializing subfield, the pulse width of a scan pulse applied to a discharge cell having undergone the selective initializing operation in the initializing period of the specific-cell initializing subfield is greater than that to a discharge cell having undergone the forced initializing operation in the initializing period of the specific-cell initializing subfield.

In this driving method, the following process may be also employed. The pulse width of the scan pulse is set to be equivalent to or greater than that of the address pulse in the address period. Regarding a discharge cell to cause address discharge, the scan pulse is also applied to the discharge cell while the address pulse is applied to the discharge cell. In the address period of the specific-cell initializing subfield, the pulse width of an address pulse applied to a discharge cell having undergone the selective initializing operation in the initializing period of the specific-cell initializing subfield is greater than that to a discharge cell having undergone the forced initializing operation in the initializing period of the specific-cell initializing subfield.

A plasma display apparatus of the present invention includes the following elements:
a panel having a plurality of discharge cells that has a data electrode and a display electrode pair formed of a scan electrode and sustain electrode; and
a driving circuit that displays gradation on the panel by setting a plurality of subfields having an initializing period, an address period, and a sustain period in one field.
   In the plasma display apparatus, in the initializing period, the driving circuit performs one of a forced initializing operation of causing initializing discharge in a discharge cell and a selective initializing operation of selectively causing initializing discharge in a discharge cell having undergone address discharge in the immediately preceding subfield. One field includes the following subfields:
a specific-cell initializing subfield having an initializing period in which the forced initializing operation is performed in a specific discharge cell and the selective initializing operation is performed in the other discharge cells; and
a selective initializing subfield having an initializing period in which the selective initializing operation is performed in all discharge cells.
   In the address period of the specific-cell initializing subfield, the period in which a scan pulse and an address pulse are simultaneously applied to a discharge cell having undergone the selective initializing operation in the initializing period of the specific-cell initializing subfield is made longer than that to a discharge cell having undergone the forced initializing operation in the initializing period of the specific-cell initializing subfield.

Thus, the contrast of an image displayed on the panel is sharpened, address discharge is caused stably, and hence the image display quality of the plasma display apparatus can be improved.

The driving circuit of the plasma display apparatus may be configured in the following manner. One field group is constituted by a plurality of temporally continuous fields, and one scan electrode group is constituted by a plurality of sequentially disposed scan electrodes. A forced initializing waveform for a forced initializing operation is applied to each of the scan electrodes constituting the scan electrode group only in one field of one field group. In the address period of the specific-cell initializing subfield, the period in which a scan pulse and an address pulse are simultaneously applied to a discharge cell is made longer in a subfield temporally more away from the initializing period having undergone the forced initializing operation.

The driving circuit of the plasma display apparatus may be also configured in the following manner. The pulse width of the address pulse is set to be equivalent to or greater than that of the scan pulse in the address period. Regarding a discharge cell to cause address discharge, the address pulse is also applied to the discharge cell while the scan pulse is applied to the discharge cell. In the address period of the specific-cell initializing subfield, the pulse width of a scan pulse applied to a discharge cell having undergone the selective initializing operation in the initializing period of the specific-cell initializing subfield is greater than that to a discharge cell having undergone the forced initializing operation in the initializing period of the specific-cell initializing subfield.

The driving circuit of the plasma display apparatus may be also configured in the following manner. The pulse width of the scan pulse is set to be equivalent to or greater than that of the address pulse in the address period. Regarding a discharge cell to cause address discharge, the scan pulse is also applied to the discharge cell while the address pulse is applied to the discharge cell. In the address period of the specific-cell initializing subfield, the pulse width of an address pulse applied to a discharge cell having undergone the selective initializing operation in the initializing period of the specific-cell initializing subfield is greater than that to a discharge cell having undergone the forced initializing operation in the initializing period of the specific-cell initializing subfield.

### BRIEF DESCRIPTION OF DRAWINGS

FIG. 1 is an exploded perspective view showing a structure of a panel used for a plasma display apparatus in accordance with a first exemplary embodiment of the present invention.

FIG. 2 is an electrode array diagram of the panel used for the plasma display apparatus in accordance with the first exemplary embodiment of the present invention.

FIG. 3 is a diagram showing one example of a coding table used for the plasma display apparatus in accordance with the first exemplary embodiment of the present invention.

FIG. 4 is a diagram for schematically showing a driving voltage waveform applied to each electrode of the panel used for the plasma display apparatus in accordance with the first exemplary embodiment of the present invention.

FIG. 5 is a diagram showing one example of a generation pattern of a forced initializing operation and selective initializing operation in accordance with the first exemplary embodiment of the present invention.

FIG. 6 is a diagram for schematically showing one example of circuit blocks constituting the plasma display apparatus in accordance with the first exemplary embodiment of the present invention.

FIG. 7 is a circuit diagram for schematically showing one configuration example of a scan electrode driver circuit used for the plasma display apparatus in accordance with the first exemplary embodiment of the present invention.

FIG. 8 is a circuit diagram for schematically showing one configuration example of a data electrode driver circuit used for the plasma display apparatus in accordance with the first exemplary embodiment of the present invention.

FIG. 9 is a timing chart for illustrating one example of an operation of the scan electrode driver circuit in the initializing period and address period of a specific-cell initializing subfield in accordance with the first exemplary embodiment of the present invention.

FIG. 10 is a diagram showing one example of a generation pattern of a forced initializing operation and selective initializing operation in accordance with a second exemplary embodiment of the present invention.

### DESCRIPTION OF EMBODIMENTS

Plasma display apparatuses in accordance with exemplary embodiments of the present invention will be described hereinafter with reference to the accompanying drawings.

### First Exemplary Embodiment

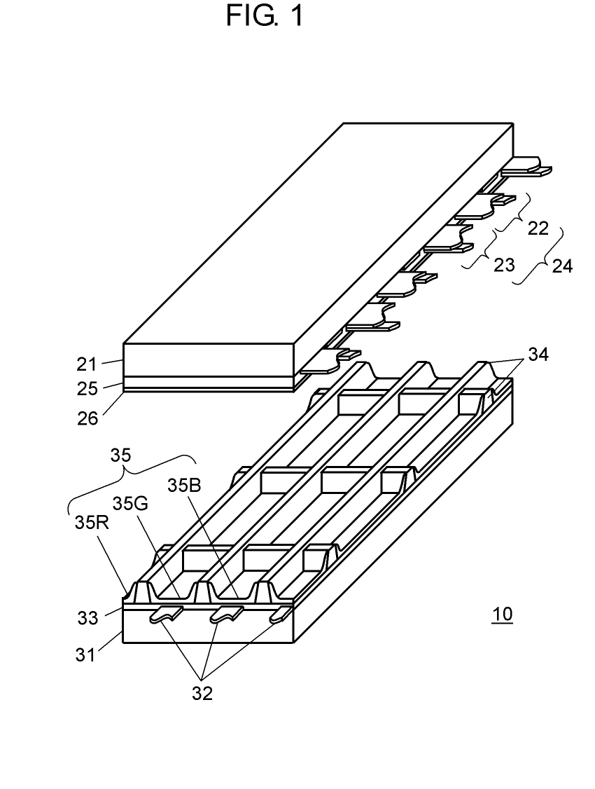

FIG. 1 is an exploded perspective view showing the structure of panel 10 used for a plasma display apparatus in accordance with a first exemplary embodiment of the present invention.

A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25.

In order to reduce the discharge start voltage in discharge cells, protective layer 26 is made of a material that has been used as the material of the panel and is mainly made of magnesium oxide (MgO). Magnesium oxide has high secondary electron emission coefficient and high durability when neon (Ne) gas and xenon (Xe) gas are filled.

Protective layer 26 may be formed of one layer, or a plurality of layers. Protective layer 26 may have a structure where there are particles on a layer.

A plurality of data electrodes 32 is formed on rear substrate 31, dielectric layer 33 is formed so as to cover data electrodes 32, and mesh barrier ribs 34 are formed on dielectric layer 33. Phosphor layers 35R for emitting light of red color (R), phosphor layers 35G for emitting light of green color (G), and phosphor layers 35B for emitting light of blue color (B) are formed on the side surfaces of barrier ribs 34 and on dielectric layer 33. Hereinafter, phosphor layers 35R, phosphor layers 35G, and phosphor layers 35B are collectively denoted as phosphor layers 35.

Front substrate 21 and rear substrate 31 are faced to each other so that display electrode pairs 24 cross data electrodes 32 with a micro discharge space sandwiched between them, and a discharge space is disposed in a clearance between front substrate 21 and rear substrate 31. The outer peripheries of them are sealed by a sealing material such as glass frit. The discharge space is filled with mixed gas of neon and xenon as discharge gas, for example.

The discharge space is partitioned into a plurality of sections by barrier ribs 34, and discharge cells are formed in the intersecting parts of display electrode pairs 24 and data electrodes 32.

Then, discharge is caused in these discharge cells and light is emitted in phosphor layers 35 in the discharge cells (lighting of the discharge cells), thereby displaying a color image on panel 10.

In panel 10, one pixel is formed of three consecutive discharge cells arranged in the extending direction of display electrode pairs 24. The three discharge cells are a discharge cell (red discharge cell) that has phosphor layer 35R and emits light of red color (R), a discharge cell (green discharge cell) that has phosphor layer 35G and emits light of green color (G), and a discharge cell (blue discharge cell) that has phosphor layer 35B and emits light of blue color (B).

The structure of panel 10 is not limited to the above-mentioned one, but may be a structure having striped barrier ribs extended in the vertical direction, for example.

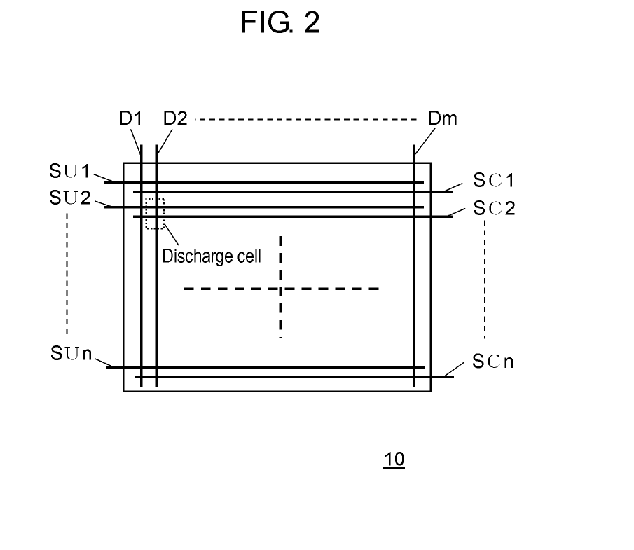

FIG. 2 is an electrode array diagram of panel 10 used for a plasma display apparatus in accordance with the first exemplary embodiment of the present invention.

Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the horizontal direction (row direction, line direction), and m data electrode D1 through data electrode Dm (data electrodes 32 in FIG. 1) extended in the vertical direction (column direction).

A discharge cell is formed in the part where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3 and n is 1080.

In the present exemplary embodiment, n is assumed to be 768. However, the present invention is not limited to this numerical value.

Next, an operation for driving panel 10 is described schematically.

The plasma display apparatus of the present exemplary embodiment drives panel 10 by a subfield method. In this subfield method, the plasma display apparatus divides one field of an image signal into a plurality of subfields on the time axis, and sets luminance weight for each subfield. Each field therefore includes a plurality of subfields having different luminance weight.

Each subfield has an initializing period, address period, and sustain period. Light emission and no light emission of each discharge cell in each subfield are controlled based on an image signal. In other words, a plurality of gradations based on the image signal is displayed on panel 10 by combining subfields of light emission and subfields of no light emission based on the image signal.

In the initializing period, an initializing operation is performed where initializing discharge is caused in the discharge cells and wall charge required for address discharge in the subsequent address period is produced on each electrode.

The initializing operation includes the following operations:
“forced initializing operation” of causing initializing discharge in a discharge cell regardless of the operation of the immediately preceding subfield; and
“selective initializing operation” of selectively causing initializing discharge only in the discharge cell having undergone address discharge in the address period and sustain discharge in the sustain period in the immediately preceding subfield.
   In the forced initializing operation, increasing ramp waveform voltage and decreasing ramp waveform voltage are applied to scan electrodes 22, and initializing discharge is caused in all discharge cells in an image display region.

In the address period, an address operation is performed where scan pulses are applied to scan electrodes 22 and address pulses are selectively applied to data electrodes 32, and thus address discharge is selectively caused in the discharge cell to emit light in the subsequent sustain period. Due to the occurrence of the address discharge, wall charge for causing sustain discharge is produced in the discharge cell.

In the sustain period, the following sustain operation is performed:
as many sustain pulses as the number derived by multiplying the luminance weight of each subfield by a predetermined proportionality constant are alternately applied to scan electrodes 22 and sustain electrodes 23, sustain discharge is caused in the discharge cell having undergone address discharge in the immediately preceding address period, and light is emitted in the discharge cell.
   This proportionality constant is luminance magnification. When the luminance magnification is two, for example, in the sustain period of the subfield of luminance weight “2”, four sustain pulses are applied to scan electrodes 22 and four sustain pulses are applied to sustain electrodes 23. Therefore, the number of sustain pulses occurring in the sustain period is eight.

The luminance weight means the ratio between the luminances displayed in respective subfields, and as many sustain pulses as the number corresponding to the luminance weight are generated in each subfield in the sustain period. Therefore, in the subfield of luminance weight “8”, for example, light is emitted at a luminance about eight times that in the subfield of luminance weight “1” and light is emitted at a luminance about four times that in the subfield of luminance weight “2”.

Therefore, for example, one field is formed of eight subfields (subfield SF1, subfield SF2, subfield SF3, subfield SF4, subfield SF5, subfield SF6, subfield SF7, subfield SF8), and subfield SF1 through subfield SF8 have luminance weights of (1, 2, 4, 8, 16, 32, 64, 128), respectively. At this time, each discharge cell can display 256 gradation values from gradation value “0” to gradation value “255”.

Thus, light can be emitted at various gradation values in respective discharge cells and an image can be displayed on panel 10 by selectively emitting light in each subfield by controlling the light emission and no light emission of each discharge cell in each subfield using a combination corresponding to the image signal.

In the present exemplary embodiment, the following example is described: one field is formed of 10 subfields, namely subfield SF1 through subfield SF10, and the subfields have luminance weights of (1, 2, 3, 6, 11, 18, 30, 44, 60, 80), respectively.

In the present exemplary embodiment, “specific-cell initializing operation” is performed in the initializing period of one subfield, of a plurality of subfields constituting one field, and a selective initializing operation is performed in all discharge cells in the initializing period of the other subfields.

The specific-cell initializing operation means an initializing operation where a forced initializing operation is performed in a specific discharge cell and a selective initializing operation is performed in the other discharge cells. Therefore, in the initializing period for performing the specific-cell initializing operation, an initializing waveform for performing the forced initializing operation is applied to the specific discharge cell, and an initializing waveform for performing the selective initializing operation is applied to the other discharge cells.

Hereinafter, an initializing waveform for performing the forced initializing operation is referred to as “forced initializing waveform”, and an initializing waveform for performing the selective initializing operation is referred to as “selective initializing waveform”. The initializing period for performing the specific-cell initializing operation is referred to as “specific-cell initializing period”, and the subfield having a specific-cell initializing period is referred to as “specific-cell initializing subfield”. The initializing period for performing the selective initializing operation in all discharge cells is referred to as “selective initializing period”, and the subfield having a selective initializing period is referred to as “selective initializing subfield”.

In the present exemplary embodiment, the first subfield (subfield SF1) of each field is set as a specific-cell initializing subfield, and the other subfields (subfield SF2 through subfield SF10) are set as selective initializing subfields.

The number of subfields constituting one field and the luminance weight of each subfield of the present invention are not limited to the above-mentioned numerical values.

The generation pattern of the forced initializing operation (relationship between scan electrodes 22 and fields for undergoing the forced initializing operation) is described later.

Next, a method of displaying gradation on panel 10 is described.

In the present exemplary embodiment, one field is formed of a plurality of subfields each of which has a preset luminance weight as discussed above. By selectively emitting light in a subfield in response to the magnitude of a gradation value to be displayed in a discharge cell, light is emitted in each discharge cell at a brightness corresponding to the gradation value and an image is displayed on panel 10. Hereinafter, the subfield to emit light is also referred to as “lit subfield”, and the subfield to emit no light is also referred to as “unlit subfield”.

There is a plurality of combinations of lit subfields and unlit subfields in one field. Hereinafter, a combination of lit subfields and unlit subfields in one field is referred to as “coding”. In the present exemplary embodiment, from a plurality of codings, a plurality of codings used for displaying gradation (codings for display) is selected, and a combination set for display is generated. Hereinafter, the combination set for display is referred to as “coding table”.

The light emission and no light emission of each subfield are controlled based on a coding belonging to the coding table, light is emitted at a luminance corresponding to the magnitude of the gradation value in the discharge cell, and an image is displayed on panel 10.

Next, coding tables used in the present exemplary embodiment are described.

In the following description, the gradation value when black is displayed (gradation value when no sustain discharge occurs) is denoted as “0”. The gradation value corresponding to luminance weight “N” is denoted as “N”.

Therefore, the gradation value displayed in the discharge cell where light is emitted only in subfield SF1 of luminance weight “1” is “1”, for example. The gradation value displayed in the discharge cell where light is emitted only in subfield SF1 of luminance weight “1” and subfield SF2 of luminance weight “2” is “3” because 1+2=3.

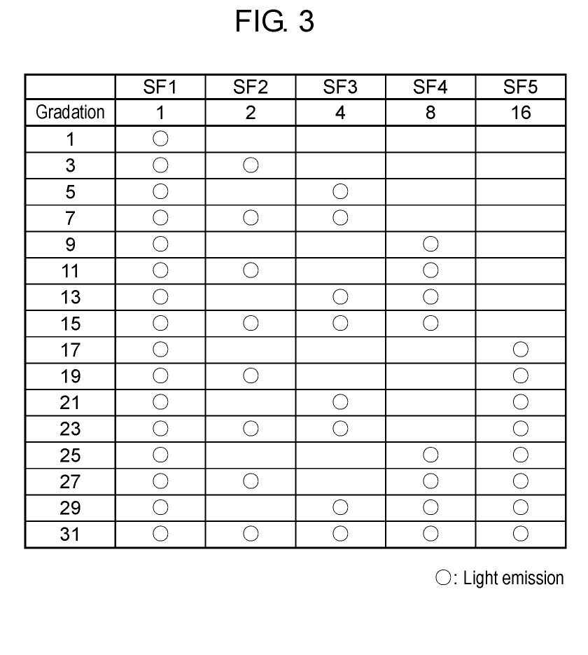

FIG. 3 is a diagram showing one example of a coding table used for the plasma display apparatus in accordance with the first exemplary embodiment of the present invention.

The numerical values existing immediately under the marks showing respective subfields in the coding table of FIG. 3 indicate luminance weights of the subfields.

To simplify the description, FIG. 3 shows a coding table where one field has five subfields, subfield SF1 through subfield SF5, and the subfields have luminance weights “1”, “2”, “4”, “8”, and “16”, respectively.

In the coding table of FIG. 3, a subfield to emit light is denoted as “O”, a subfield to emit no light is denoted as a blank, and the leftmost column shows gradation values displayed at respective codings.

For example, based on the coding table of FIG. 3, light is emitted in subfield SF1 and subfield SF2 in the discharge cell to display gradation value “3”. In the discharge cell to display gradation value “23”, light is emitted in subfield SF1, subfield SF2, subfield SF3, and subfield SF5.

The coding table of FIG. 3 shows a coding set having rule “light is always emitted in subfield SF1 in the discharge cells to display gradation value “1” or higher”. This rule can be translated into “the discharge cell that has undergone no light emission in subfield SF1 undergoes no light emission in subfield SF2 and later either”.

In other words, in the coding table of FIG. 3, subfields of light emission and subfields of no light emission are combined so that, if light is not emitted in subfield SF1, light is not emitted in the subfields after subfield SF1 either.

In the coding table of FIG. 3, therefore, light is always emitted in subfield SF1 in the discharge cells to display gradation value “1” or higher. The plasma display apparatus of the present exemplary embodiment creates a coding table according to this rule, combines subfields of light emission and subfields of no light emission according to this rule, and displays gradation on panel 10.

When an image is displayed on panel 10 based on the coding table of FIG. 3, even-numbered gradation values such as “2”, “4”, and “6” cannot be used. However, these gradation values can be displayed pseudo on panel 10 using technology such as generally known dither processing or error diffusion processing.

Next, one example of a driving voltage waveform for driving panel 10 of the present exemplary embodiment and its operation are described schematically,

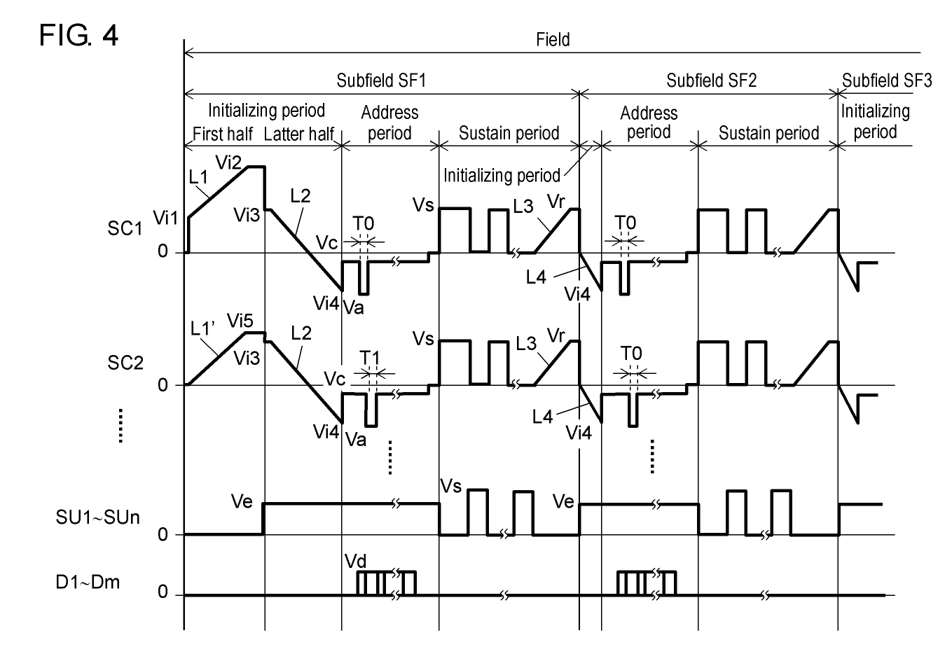

FIG. 4 is a diagram for schematically showing a driving voltage waveform applied to each electrode of panel 10 used for the plasma display apparatus in accordance with the first exemplary embodiment of the present invention.

FIG. 4 shows driving voltage waveforms applied to scan electrode SC1 for firstly undergoing an address operation in the address period, scan electrode SC2 for secondarily undergoing the address operation in the address period, sustain electrode SU1 through sustain electrode SUn, and data electrode D1 through data electrode Dm. Each of scan electrode SCi, sustain electrode SUi, and data electrode Dk discussed later means the electrode that is selected from each kind of electrode based on image data (which indicates light emission or no light emission in each subfield).

FIG. 4 shows subfield SF1 as a specific-cell initializing subfield, and subfield SF2 and subfield SF3 as selective initializing subfields. The waveform of the driving voltage applied to scan electrodes 22 in the initializing period differs between subfield SF1 and subfield SF2 through subfield SF10.

Subfield SF4 and later are not shown, but the subfields other than subfield SF1 are selective initializing subfields, and substantially the same driving voltage waveform is generated in these subfields in each period except for the number of generated sustain pulses. FIG. 4 shows a field where the forced initializing operation is performed in a discharge cell having scan electrode SC1, and not the forced initializing operation but the selective initializing operation is performed in a discharge cell having scan electrode SC2. The field of FIG. 4 is different from the subsequent fields in scan electrode 22 to which a forced initializing waveform is applied in the initializing period of subfield SF1 of each field. Except for this scan electrode, substantially the same driving voltage waveform is applied to each electrode. Hereinafter, the field of FIG. 4 is referred to as “first field”.

First, subfield SF1 as a specific-cell initializing subfield is described.

In the present exemplary embodiment, in the specific-cell initializing subfield (subfield SF1) of the first field, a forced initializing waveform for performing the forced initializing operation is applied to (1+5×N)-th (N is an integer of 0 or larger) scan electrode SC(1+5×N), namely first, sixth, eleventh, etc. from the top of panel 10. Then, a selective initializing waveform for performing a selective initializing operation is applied to the other scan electrodes 22, namely (2+5×N)-th scan electrode SC(2+5×N), (3+5×N)-th scan electrode SC(3+5×N), (4+5×N)-th scan electrode SC(4+5×N), and (5+5×N)-th scan electrode SC(5+5×N). FIG. 3 shows scan electrode SC1 as a typical example of scan electrode SC(1+5×N) and shows scan electrode SC2 as a typical example of the other scan electrodes 22.

In the first half of the initializing period of subfield SF1 where the specific-cell initializing operation is performed, voltage 0 (V) is applied to data electrode D1 through data electrode Dm, and 0 (V) is also applied to sustain electrode SU1 through sustain electrode SUn. To scan electrode SC(1+5×N) (e.g. scan electrode SC1) to which a forced initializing waveform is applied, voltage 0 (V) is applied, then voltage Vi1 is applied, and ramp waveform voltage, which gently (for example, at a gradient of about 1.3 V/μsec) increases from voltage Vi1 to voltage V12, is applied. The ramp waveform voltage is referred to as “up-ramp voltage L1”. At this time, voltage Vi1 is set at a voltage (namely, discharge does not occur in a discharge cell) lower than the discharge start voltage with respect to sustain electrode SU(1+5×N). Voltage V12 is set at a voltage (namely, discharge occurs in a discharge cell regardless of the existence of discharge before it) exceeding the discharge start voltage with respect to sustain electrode SU(1+5×N).

While up-ramp voltage L1 increases, feeble initializing discharge continuously occurs between scan electrode SC(1+5×N) and sustain electrode SU(1+5×N) in each discharge cell, and feeble initializing discharge continuously occurs between scan electrode SC(1+5×N) and data electrode D1 through data electrode Dm in each discharge cell. Then, wall voltage of negative polarity is accumulated on scan electrode SC(1+5×N), and wall voltage of positive polarity is accumulated on sustain electrode SU(1+5×N) and data electrode D1 through data electrode Dm crossing scan electrode SC(1+5×N). Furthermore, priming particles occur that shorten the discharge delay time of address discharge (the discharge delay time is time length after the voltage applied to the discharge cell exceeds the discharge start voltage until discharge occurs in the discharge cell). The wall voltage on the electrodes means the voltage that is generated by the wall charge accumulated on dielectric layer 25 for covering the electrodes, protective layer 26, or phosphor layers 35.

In the latter half of the initializing period in subfield SF1, positive voltage Ve is applied to sustain electrode SU1 through sustain electrode SUn, and voltage 0 (V) is applied to data electrode D1 through data electrode Dm. Down-ramp waveform voltage, which gently (for example, at a gradient of about −1.5 V/μsec) decreases from voltage V13 to negative voltage V14, is applied to scan electrode SC(1+5×N). The down-ramp waveform voltage is referred to as “down-ramp voltage L2”. Voltage V13 is set at a voltage lower than the discharge start voltage with respect to sustain electrode SU(1+5×N), and voltage V14 is set at a voltage exceeding the discharge start voltage with respect to sustain electrode SU(1+5×N).

While down-ramp voltage L2 is applied to scan electrode SC(1+5×N), feeble initializing discharge occurs between scan electrode SC(1+5×N) and sustain electrode SU(1+5×N) in each discharge cell, and feeble initializing discharge continuously occurs between scan electrode SC(1+5×N) and data electrode D1 through data electrode Dm in each discharge cell. Thus, the wall voltage of negative polarity on scan electrode SC(1+5×N), the wall voltage of positive polarity on sustain electrode SU(1+5×N), and the wall voltage of positive polarity on data electrode D1 through data electrode Dm crossing scan electrode SC(1+5×N) are adjusted to voltages appropriate to the address operation in the address period. Furthermore, priming particles occur which shorten the discharge delay time of address discharge.

The above-mentioned voltage waveform is a forced initializing waveform for causing initializing discharge in a discharge cell regardless of the operation of the immediately preceding subfield. The operation of applying the forced initializing waveform to scan electrodes 22 is a forced initializing operation. In subfield SF1 of the first field, the initializing operation in the discharge cell formed on (1+5×N)-th scan electrode SC(1+5×N) from the top of panel 10 becomes a forced initializing operation of causing initializing discharge in a discharge cell regardless of the operation of the immediately preceding subfield.

In the first half of the initializing period of subfield SF1, not voltage Vi1 but up-ramp voltage L1′, which gently increases from voltage 0 (V) to voltage Vi5, is applied to the other scan electrodes 22. Namely, the other scan electrodes 22 are (2+5×N)-th scan electrode SC(2+5×N) (e.g. scan electrode SC2), (3+5×N)-th scan electrode SC(3+5×N) (e.g. scan electrode SC3), (4+5×N)-th scan electrode SC(4+5×N) (e.g. scan electrode SC4), and (5+5×N)-th scan electrode SC(5+5×N) (e.g. scan electrode SC5). Up-ramp voltage L1′ has a voltage waveform that continuously increases at the same gradient as that of up-ramp voltage L1 for the same time as that of up-ramp voltage L1. Therefore, voltage Vi5 is equal to the voltage derived by subtracting voltage Vi1 from voltage Vi2. At this time, each voltage and up-ramp voltage L1′ are set so that voltage Vi5 is lower than the discharge start voltage with respect to sustain electrode SU(2+5×N), sustain electrode SU(3+5×N), sustain electrode SU(4+5×N), and sustain electrode SU(5+5×N). Thus, discharge does not substantially occur in the discharge cell to which up-ramp voltage L1′ has been applied.

In the latter half of the initializing period in subfield SF1, down-ramp voltage L2 is applied to scan electrode SC(2+5×N), scan electrode SC(3+5×N), scan electrode SC(4+5×N), and scan electrode SC(5+5×N), similarly to scan electrode SC(1+5×N).

While down-ramp voltage L2 is applied to scan electrode SC(2+5×N), scan electrode SC(3+5×N), scan electrode SC(4+5×N), and scan electrode SC(5+5×N), feeble initializing discharge occurs in the discharge cell having undergone sustain discharge in the sustain period of the immediately preceding subfield (subfield SF10 in FIG. 4). Due to this initializing discharge, the wall voltage of negative polarity on scan electrodes 22, the wall voltage of positive polarity on sustain electrodes 23, and the wall voltage of positive polarity on data electrodes 32 are adjusted to voltages appropriate to the address operation in the address period. Thus, the wall voltage in the discharge cell is adjusted to a wall voltage appropriate to the address operation. Furthermore, priming particles occur which shorten the discharge delay time of address discharge.

While, in the discharge cell having undergone no sustain discharge in the sustain period of the immediately preceding subfield (sub field SF10), initializing discharge does not occur and the wall voltage is kept as it is.

The above-mentioned voltage waveform is a selective initializing waveform for selectively causing initializing discharge in a discharge cell having undergone the address operation in the address period of the immediately preceding subfield. The operation of applying the selective initializing waveform to scan electrodes 22 is a selective initializing operation. In subfield SF1 of the first field, the initializing operation in the discharge cells formed on (2+5×N)-th scan electrode SC(2+5×N), (3+5×N)-th scan electrode SC(3+5×N), (4+5×N)-th scan electrode SC(4+5×N), and (5+5×N)-th scan electrode SC(5+5×N) from the top of panel 10 becomes a selective initializing operation of selectively causing initializing discharge in the discharge cell having undergone the address operation in the address period of the immediately preceding subfield.

Thus, the specific-cell initializing operation in the initializing period of the specific-cell initializing subfield (subfield SF1) is completed. Then, in the initializing period of the specific-cell initializing subfield, discharge cells for undergoing the forced initializing operation and discharge cells for undergoing the selective initializing operation are mixed.

In the address period of subfield SF1, voltage Ve is applied to sustain electrode SU1 through sustain electrode SUn, voltage 0 (V) is applied to data electrode D1 through data electrode Dm, and voltage Vc is applied to scan electrode SC1 through scan electrode SCn.

Next, a scan pulse of negative polarity of negative voltage Va is applied to first (first row) scan electrode SC1 from the top of panel 10. An address pulse of positive polarity of positive voltage Vd is applied to data electrode Dk of the discharge cell to emit light in the first row, of data electrode D1 through data electrode Dm.

In the discharge cell existing in the intersecting part of data electrode Dk to which voltage Vd of an address pulse is applied and scan electrode SC1 to which voltage Va of a scan pulse is applied, discharge occurs between data electrode Dk and scan electrode SC1 after the discharge delay time after the voltage difference between data electrode Dk and scan electrode SC1 exceeds the discharge start voltage.

Since voltage Ve is applied to sustain electrode SU1 through sustain electrode SUn, discharge occurring between data electrode Dk and scan electrode SC1 causes discharge between sustain electrode SU1 and scan electrode SC1 that exist in a region crossing data electrode Dk. Thus, address discharge is caused in the discharge cell (this discharge cell is to emit light) to which voltage Va of a scan pulse and voltage Vd of an address pulse are applied simultaneously.

In the discharge cell having undergone address discharge, positive wall voltage is accumulated on scan electrode SC1, negative wall voltage is accumulated on sustain electrode SU1, and negative wall voltage is accumulated also on data electrode Dk.

Thus, the address operation in the discharge cell of the first row is completed. In the discharge cell to which no address pulse has been applied, address discharge does not occur and wall voltage after the completion of the initializing period is kept.

Next, a scan pulse of voltage Va is applied to second (second row) scan electrode SC2 from the top of panel 10, and an address pulse of voltage Vd is applied to data electrode Dk corresponding to the discharge cell to emit light in the second row. Thus, in the discharge cell of the second row to which a scan pulse and address pulse are applied simultaneously, address discharge occurs after the discharge delay time after the voltage difference between data electrode Dk and scan electrode SC2 exceeds the discharge start voltage. Then, positive wall voltage is accumulated on scan electrode SC2, negative wall voltage is accumulated on sustain electrode SU2, and negative wall voltage is accumulated also on data electrode Dk. In the discharge cell to which no address pulse has been applied, address discharge does not occur. Thus, the address operation in the discharge cell of the second row is completed.

A similar address operation is sequentially performed until the discharge cell of the n-th row in the order of scan electrode SC3, scan electrode SC4, . . . , scan electrode SCn. Thus, in the address period, address discharge is selectively caused in the discharge cell to emit light, and wall charge for sustain discharge is produced in the discharge cell.

In the present exemplary embodiment, the period in which a scan pulse and an address pulse are simultaneously applied to a discharge cell is referred to as “address time”. In the discharge cell having undergone a forced initializing operation in the specific-cell initializing period, the address time in the address period (namely, the address period of the specific-cell initializing subfield) immediately after the specific-cell initializing period is referred to as T0. In the discharge cell having undergone a selective initializing operation in the specific-cell initializing period, the address time in the address period (namely, the address period of the specific-cell initializing subfield) immediately after the specific-cell initializing period is referred to as T1. In the present exemplary embodiment, address time T1 is set to be longer than address time T0.

It is considered that a generation timing lag occurs between the scan pulse and address pulse or the pulse width of the scan pulse differs from that of the address pulse. Therefore, strictly speaking, the pulse width of the scan pulse or that of the address pulse is different from the address time. In the present exemplary embodiment, however, to simplify the description, the pulse width of the address pulse is set to be at least equivalent to or greater than the pulse width of the scan pulse, and the address pulse is applied to the discharge cell in the period in which the scan pulse is applied to the discharge cell. Thus, the pulse width of the scan pulse can be considered to be equal to the address time. Therefore, the pulse width of the scan pulse is assumed to be equal to the address time.

Therefore, in the present exemplary embodiment, in the discharge cell having undergone a forced initializing operation in the specific-cell initializing period, the pulse width of the scan pulse occurring in the address period immediately after the specific-cell initializing period is set to be T0. In the discharge cell having undergone a selective initializing operation in the specific-cell initializing period, the pulse width of the scan pulse occurring in the address period immediately after the specific-cell initializing period is set to be T1. Pulse width T1 is set at a time longer than pulse width T0.

In the example of FIG. 4, in the address period of subfield SF1, the pulse width of the scan pulse applied to scan electrode SC1 is T0, and the pulse width of the scan pulse applied to scan electrode SC2 is T1. Pulse width T1 of the scan pulse applied to scan electrode SC2 is longer than pulse width T0 of the scan pulse applied to scan electrode SC1.

This is for the following reason.

In the discharge cell having undergone a forced initializing operation in the specific-cell initializing period, priming particles generated by the forced initializing operation sufficiently remain.

In the discharge cell having undergone a selective initializing operation in the specific-cell initializing period, initializing discharge occurs if the discharge cell has undergone sustain discharge in the sustain period (for example, sustain period of subfield SF10) immediately before the specific-cell initializing period, and initializing discharge occurs if the discharge cell has not undergone sustain discharge. Therefore, in the discharge cell undergoing no initializing discharge, the number of priming particles is apt to be insufficient comparing with the discharge cell undergoing initializing discharge. In the discharge cell where the number of priming particles is insufficient, the discharge delay time of address discharge is apt to become long and address discharge is apt to become unstable comparing with the discharge cell where priming particles remain sufficiently.

In the discharge cell where priming particles remain sufficiently due to occurrence of the initializing discharge and the discharge delay time of address discharge is relatively short, the address time can be set to be relatively short.

In the discharge cell where initializing discharge does not occur, the number of priming particles relatively decreases, the discharge delay time of address discharge is relatively long, it is desired to relatively increase the address time in order to stably cause address discharge.

Thus, in the present exemplary embodiment, in the discharge cell having undergone a selective initializing operation in the specific-cell initializing period, the address time in the address period immediately after the specific-cell initializing period is made longer than that in the discharge cell having undergone a forced initializing operation in the specific-cell initializing period

In other words, in the discharge cell having undergone a selective initializing operation in the specific-cell initializing period, the pulse width of the scan pulse occurring in the address period immediately after the specific-cell initializing period is set to be T1. Pulse width T1 is set to be longer than pulse width T0 of the scan pulse occurring in the address period immediately after the specific-cell initializing period in the discharge cell having undergone a forced initializing operation in the specific-cell initializing period.

Thus, also in the discharge cell having undergone a selective initializing operation in the specific-cell initializing period, address discharge can be caused stably.

When the pulse width of the scan pulse is set to be at least equivalent to or greater than the pulse width of the address pulse and the scan pulse is also applied to the discharge cell in the period in which the address pulse is applied to the discharge cell, the pulse width of the address pulse can be considered to be equal to the address time.

Voltage Ve applied to sustain electrode SU1 through sustain electrode SUn in the latter half of the initializing period may be different from voltage Ve applied to sustain electrode SU1 through sustain electrode SUn in the address period.

In the sustain period of subfield SF1, voltage 0 (V) is firstly applied to sustain electrode SU1 through sustain electrode SUn. Then, sustain pulses of positive voltage Vs are applied to scan electrode SC1 through scan electrode SCn.

Due to application of the sustain pulses, the voltage difference between scan electrode SCi and sustain electrode SUi becomes a voltage derived by adding the difference between the wall voltage on scan electrode SCi and that on sustain electrode SUi to voltage Vs of the sustain pulses. Thus, in the discharge cell having undergone address discharge in the immediately preceding address period, the voltage difference between scan electrode SCi and sustain electrode SUi exceeds the discharge start voltage, and sustain discharge occurs. Then, ultraviolet rays generated by this discharge cause phosphor layer 35 to emit light. By this discharge, negative wall voltage is accumulated on scan electrode SCi, and positive wall voltage is accumulated on sustain electrode SUi. Positive wall voltage is also accumulated on data electrode Dk.

In the discharge cell having undergone no address discharge in the immediately preceding address period, the wall voltage is low, and hence voltage difference between scan electrode 22 and sustain electrode 23 exceeds the discharge start voltage and sustain discharge does not occur.

Subsequently, voltage 0 (V) is applied to scan electrode SC1 through scan electrode SCn, and sustain pulses of voltage Vs are applied to sustain electrode SU1 through sustain electrode SUn. In the discharge cell having undergone the sustain discharge immediately before it, therefore, sustain discharge occurs again. In this discharge cell, ultraviolet rays generated by the sustain discharge cause phosphor layer 35 to emit light, negative wall voltage is accumulated on sustain electrode SUi, and positive wall voltage is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, in the discharge cell having undergone the address discharge in the immediately preceding address period, sustain discharge occurs over times corresponding to the luminance weight and light is emitted at a luminance corresponding to the luminance weight.

After the generation of the sustain pulses in the sustain period (at the end of the sustain period), in the state where voltage 0 (V) is applied to sustain electrode SU1 through sustain electrode SUn and data electrode D1 through data electrode Dm, ramp waveform voltage, which gently (for example, at a gradient of about 10 V/μsec) increases from voltage 0 (V) to voltage Vr, is applied to scan electrode SC1 through scan electrode SCn. Hereinafter, the ramp waveform voltage is referred to as “erasing ramp voltage L3”.

When voltage Vr is set at a voltage exceeding the discharge start voltage, the following phenomenon occurs. While erasing ramp voltage L3 applied to scan electrode SC1 through scan electrode SCn increases beyond the discharge start voltage, feeble discharge (erasing discharge) continuously occurs between scan electrode SCi and sustain electrode SUi in the discharge cell having undergone the sustain discharge.

Charged particles generated by the feeble discharge are accumulated as wall charge on sustain electrode SUi and scan electrode SCi so as to reduce the voltage difference between sustain electrode SUi and scan electrode SCi. Thus, the wall voltage on scan electrode SCi and the wall voltage on sustain electrode SUi are reduced while the wall voltage of positive polarity is left on data electrode Dk. Unnecessary wall charge in the discharge cell is thus erased.

When the voltage applied to scan electrode SC1 through scan electrode SCn arrives at voltage Vr, the voltage applied to scan electrode SC1 through scan electrode SCn is decreased to voltage 0 (V). Thus, the sustain operation in the sustain period of subfield SF1 is completed.

Thus, subfield SF1 is completed.

In a subfield where the number of sustain pulses generated in the sustain period is set at “0”, sustain pulses are not applied to scan electrode SC1 through scan electrode SCn and sustain electrode SU1 through sustain electrode SUn, and only erasing ramp voltage L3 is applied to scan electrode SC1 through scan electrode SCn. In this case, erasing discharge occurs only in the discharge cell having undergone address discharge in the immediately preceding address period.

Next, a selective initializing subfield is described while subfield SF2 is taken as an example.

In the initializing period of subfield SF2, voltage Ve of positive polarity is applied to sustain electrode SU1 through sustain electrode SUn, and voltage 0 (V) is applied to data electrode D1 through data electrode Dm.

Down-ramp voltage L4, which decreases at the same gradient as that of down-ramp voltage L2 from a voltage (e.g. voltage 0 (V)) lower than the discharge start voltage to voltage V14 of negative polarity, is applied to scan electrode SC1 through scan electrode SCn. Voltage Vi4 is set at a voltage exceeding the discharge start voltage.

While down-ramp voltage L4 is applied to scan electrode SC1 through scan electrode SCn, feeble initializing discharge occurs in the discharge cell having undergone the sustain discharge in the sustain period of the immediately preceding subfield (subfield SF1 in FIG. 4).

Then, this initializing discharge reduces the wall voltages on scan electrode SCi and sustain electrode SUi. The excess part of the wall voltage accumulated on data electrode Dk is discharged. The wall voltage in the discharge cell is adjusted to a wall voltage suitable for an address operation.

In the discharge cell having undergone no sustain discharge in the sustain period of the immediately preceding subfield (subfield SF1), initializing discharge does not occur, and the wall voltage is kept as it is.

Thus, the above-mentioned waveform is a selective initializing waveform for selectively causing initializing discharge in the discharge cell having undergone an address operation in the address period of the immediately preceding subfield. An operation of applying the selective initializing waveform to scan electrode 22 is a selective initializing operation.

Thus, the selective initializing operation in the initializing period of subfield SF2 as the selective initializing subfield is completed.

The selective initializing waveform generated in the initializing period of subfield SF1 is different from that in the initializing period of subfield SF2. In the selective initializing waveform generated in the initializing period of subfield SF1, discharge does not occur in the first half of the initializing period, and the operation in the latter half of the initializing period is substantially equivalent to the selective initializing operation in the initializing period of subfield SF2. Therefore, in the present exemplary embodiment, the initializing waveform that occurs in the initializing period of subfield SF1 and has up-ramp voltage L1′ and down-ramp voltage L2 is assumed as a selective initializing waveform.

In the address period of subfield SF2, a driving voltage waveform similar to that in the address period of subfield SF1 is applied to each electrode. The address time in the address period of subfield SF2 is different from the address time in the address period of subfield SF1, and is constant with respect to all discharge cells. In other words, the pulse width of the scan pulses generated in the address period of subfield SF2 is constant with respect to all scan electrodes 22, and is T0, for example.

In the subsequent sustain period of subfield SF2, similarly to the sustain period of subfield SF1, as many sustain pulses as the number corresponding to the luminance weight are alternately applied to scan electrode SC1 through scan electrode SCn and sustain electrode SU1 through sustain electrode SUn.

In each of subfield SF3 and later, a driving voltage waveform similar to that in subfield SF2 is applied to each electrode except for the number of sustain pulses generated in the sustain period.

The driving voltage waveform applied to each electrode of panel 10 of the present exemplary embodiment has been described schematically.

In the present exemplary embodiment, the following voltage values are applied to respective electrodes, for example. Voltage Vi1 is 150 (V), voltage Vi2 is 350 (V), voltage Vi3 is 200 (V), voltage Vi4 is −180 (V), voltage Vi5 is 202 (V), voltage Vc is −50 (V), voltage Va is −200 (V), voltage Vs is 200 (V), voltage Vr is 200 (V), voltage Ve is 160 (V), and voltage Vd is 60 (V).

For example, address time T0 is 1.15 μsec (pulse width T0 is 1.15 μsec), and address time T1 is 1.4 μsec (pulse width T1 is 1.4 μsec).

However, specific numerical values such as the above-mentioned voltage values, time, and gradients are simply one example, and voltage values, time, and gradients of the present invention are not limited to the above-mentioned numerical values. Preferably, the voltage values, time, and gradients are set optimally based on the discharge characteristics of the panel or the specification of the plasma display apparatus. For example, voltage Vi5 may be equal to voltage Vi3.

In the example having been described in the present exemplary embodiment, subfield SF1 is assumed as a specific-cell initializing subfield for undergoing a forced initializing operation, and the other subfields (subfield SF2 through subfield SF10) are assumed as selective initializing subfields for undergoing a selective initializing operation. However, the present invention is not limited to this structure. For example, subfield SF1 may be assumed as a selective initializing subfield, or a plurality of subfields may be assumed as specific-cell initializing subfields.

Next, the relationship between scan electrode 22 to undergo a forced initializing operation and a field is described. Hereinafter, an operation where a forced initializing waveform is applied to scan electrode 22 and a forced initializing operation is performed in the discharge cell formed on the scan electrode 22 is also referred to as “a forced initializing operation is performed in scan electrode 22”.

In the present exemplary embodiment, scan electrode 22 to which a forced initializing waveform is applied in the specific-cell initializing period is set based on the following rule. Scan electrode 22 to which a forced initializing waveform is applied in the specific-cell initializing period is also referred to as “specific scan electrode”.

When the forced initializing operation is performed in one scan electrode 22 once for one of N temporally continuous fields (N is a natural number), the N temporally continuous fields are set as one field group. N continuously arranged scan electrodes 22 are set as one scan electrode group.

Under this condition, rule 1 and rule 2 are defined as below.

(Rule 1) The number of fields to undergo a forced initializing operation in one scan electrode 22 is one in each field group. In other words, to each scan electrode 22, a forced initializing waveform is applied only in the specific-cell initializing period of one field, of each field group, and a selective initializing waveform is applied in the specific-cell initializing periods of the other fields.

(Rule 2) The number of scan electrodes 22 to undergo a forced initializing operation in one field is one in each scan electrode group. In other words, in the specific-cell initializing period of one field, a forced initializing waveform is applied only to one scan electrode 22, of each scan electrode group, and a selective initializing waveform is applied to the other scan electrodes 22.

When N is five or larger, namely when one field group is constituted by five or more fields, the following rule 3 is defined.

(Rule 3) To scan electrode SCx−1 and scan electrode SCx+1 that are adjacent to scan electrode SCx to which a forced initializing waveform is applied in the specific-cell initializing period of one field, no forced initializing waveform is applied and a selective initializing waveform is applied, at least in the specific-cell initializing periods of that field and the next field.

Next, a generation pattern of the forced initializing operation based on these rules is described.

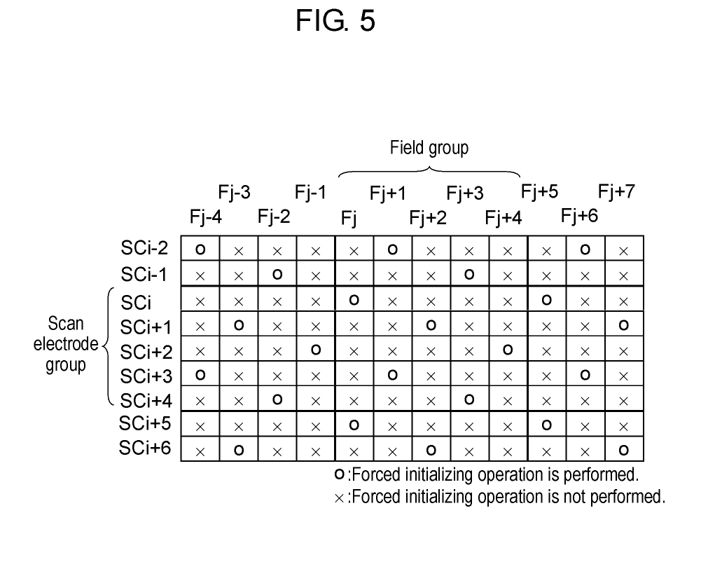

FIG. 5 is a diagram showing one example of a generation pattern of a forced initializing operation and selective initializing operation in accordance with the first exemplary embodiment of the present invention. In FIG. 5, the horizontal axis shows field, and the vertical axis shows scan electrode 22.

FIG. 5 shows one example when N is set at five and five temporally continuous fields are set as one field group and five sequentially disposed scan electrodes 22 are set as one scan electrode group. In the example of FIG. 5, one field group is constituted by field Fj, field Fj+1, field Fj+2, field Fj+3, and field Fj+4, and one scan electrode group is constituted by scan electrode SCi, scan electrode SCi+1, scan electrode SCi+2, scan electrode SCi+3, and scan electrode SCi+4.

“O” of FIG. 5 shows that the forced initializing operation is performed in the initializing period of subfield SF1 (namely, a forced initializing operation is performed in the specific-cell initializing period). “x” shows that the forced initializing operation is not performed in the initializing period of subfield SF1 (namely, a selective initializing operation is performed in the specific-cell initializing period).

In the example of FIG. 5, field Fj is assumed to be a first field, field Fj+1 is assumed to be a second field, field Fj+2 is assumed to be a third field, field Fj+3 is assumed to be a fourth field, and field Fj+4 is assumed to be a fifth field.

In the specific-cell initializing subfield (subfield SF1) of the first field (e.g. field Fj) and in the specific-cell initializing period, a forced initializing waveform for a forced initializing operation is applied to (1+5×N)-th scan electrode SC(1+5×N) (e.g. scan electrode SCi) from the top of panel 10, and not a forced initializing waveform but a selective initializing waveform for a selective initializing operation is applied to the other scan electrodes 22.

In the specific-cell initializing subfield (subfield SF1) of the second field (e.g. field Fj+1) and in the specific-cell initializing period, a forced initializing waveform is applied to (4+5×N)-th scan electrode SC(4+5×N) (e.g. scan electrode SCi+3) from the top of panel 10, and a selective initializing waveform is applied to the other scan electrodes 22.

In the specific-cell initializing subfield (subfield SF1) of the third field (e.g. field Fj+2) and in the specific-cell initializing period, a forced initializing waveform is applied to (2+5×N)-th scan electrode SC(2+5×N) (e.g. scan electrode SCi+1) from the top of panel 10, and a selective initializing waveform is applied to the other scan electrodes 22.

In the specific-cell initializing subfield (subfield SF1) of the fourth field (e.g. field Fj+3) and in the specific-cell initializing period, a forced initializing waveform is applied to (5+5×N)-th scan electrode SC(5+5×N) (e.g. scan electrode SCi+4) from the top of panel 10, and a selective initializing waveform is applied to the other scan electrodes 22.

In the specific-cell initializing subfield (subfield SF1) of the fifth field (e.g. field Fj+4) and in the specific-cell initializing period, a forced initializing waveform is applied to (3+5×N)-th scan electrode SC(3+5×N) (e.g. scan electrode SCi+2) from the top of panel 10, and a selective initializing waveform is applied to the other scan electrodes 22.

Thus, in the present exemplary embodiment, the number of fields to undergo a forced initializing operation in one scan electrode 22 is one in each field group (rule 1).

For example, in the example of FIG. 5, to scan electrode SCi, a forced initializing waveform is applied only in the specific-cell initializing period of the first field of each field group. To scan electrode SCi+1, a forced initializing waveform is applied only in the specific-cell initializing period of the third field of each field group. To scan electrode SCi+2, a forced initializing waveform is applied only in the specific-cell initializing period of the fifth field of each field group. To scan electrode SCi+3, a forced initializing waveform is applied only in the specific-cell initializing period of the second field of each field group. To scan electrode SCi+4, a forced initializing waveform is applied only in the specific-cell initializing period of the fourth field of each field group. This is similar to the other field groups.

Thus, the number of forced initializing operations is decreased to ⅕ of that when the forced initializing operation is performed in all discharge cells in each field. Therefore, light emission caused by the forced initializing operation is also reduced to ⅕.

In the present exemplary embodiment, by driving panel 10 in that manner, the light emission as a factor for increasing the luminance of black level is minimized to reduce the luminance of black level, and the contrast ratio of the display image is improved.

One of factors for increasing the luminance of black level is light emission by initializing discharge. The selective initializing operation does not substantially affect the brightness of the luminance of black level because discharge does not occur in the discharge cell having undergone no sustain discharge in the immediately preceding subfield. However, the forced initializing operation affects the brightness of the luminance of black level because initializing discharge occurs in the discharge cell regardless of the operation in the immediately preceding subfield. In other words, the higher the occurrence frequency of the forced initializing operation is, the higher the luminance of black level is. Therefore, when the frequency of the forced initializing operation in each discharge cell is reduced, the luminance of black level of the display image can be reduced and the contrast can be sharpened.

In the present exemplary embodiment, the number of forced initializing operations is decreased to ⅕ of that when the forced initializing operation is performed in all discharge cells in each field. Therefore, the luminance of black level of the display image can be reduced correspondingly and the contrast ratio of the display image can be improved.

In the present exemplary embodiment, the number of scan electrodes 22 to undergo a forced initializing operation in one field is one in each scan electrode group (rule 2).

In the example of FIG. 5, in field Fj, a forced initializing waveform is applied to (1+5×N)-th scan electrode SC(1+5×N) (e.g. scan electrode SCi) from the top of panel 10. In field Fj+1, a forced initializing waveform is applied to (4+5×N)-th scan electrode SC(4+5×N) (e.g. scan electrode SCi+3) from the top of panel 10. In field Fj+2, a forced initializing waveform is applied to (2+5×N)-th scan electrode SC(2+5×N) (e.g. scan electrode SCi+1) from the top of panel 10. In field Fj+3, a forced initializing waveform is applied to (5+5×N)-th scan electrode SC(5+5×N) (e.g. scan electrode SCi+4) from the top of panel 10. In field Fj+4, a forced initializing waveform is applied to (3+5×N)-th scan electrode SC(3+5×N) (e.g. scan electrode SCi+2) from the top of panel 10. This is similar to the other scan electrode groups.

Thus, scan electrodes 22 to undergo the forced initializing operation are dispersed in respective fields, so that flicker (screen fluctuates) can be reduced comparing with the case where scan electrodes 22 to undergo the forced initializing operation are concentrated to one field.

Here, “scan electrodes 22 to undergo the forced initializing operation are concentrated to one field” indicates a case where, in each specific-cell initializing period, a forced initializing operation is performed in all scan electrodes 22 in one field of a field group and a selective initializing operation is performed in all scan electrodes 22 in the other fields.

In the present exemplary embodiment, to scan electrode SCx−1 and scan electrode SCx+1 that are adjacent to scan electrode SCx to which a forced initializing waveform is applied in the specific-cell initializing period of one field, no forced initializing waveform is applied and a selective initializing waveform is applied, at least in the specific-cell initializing periods of that field and the next field (rule 3).

In the example of FIG. 5, a forced initializing waveform is applied to scan electrode SCi in the specific-cell initializing period of field Fj, but no forced initializing waveform is applied and a selective initializing waveform is applied to scan electrode SCi-1 and scan electrode SCi+1 that are adjacent to scan electrode SCi in the specific-cell initializing periods of field Fj and next field Fj+1. Similarly, a forced initializing waveform is applied to scan electrode SCi+3 in the specific-cell initializing period of field Fj+1, but no forced initializing waveform is applied and a selective initializing waveform is applied to scan electrode SCi+2 and scan electrode SCi+4 that are adjacent to scan electrode SCi+3 in the specific-cell initializing periods of field Fj+1 and next field Fj+2. Similarly, a forced initializing waveform is applied to scan electrode SCi+1 in the specific-cell initializing period of field Fj+2, but no forced initializing waveform is applied and a selective initializing waveform is applied to scan electrode SCi and scan electrode SCi+2 that are adjacent to scan electrode SCi+1 in the specific-cell initializing periods of field Fj+2 and next field Fj+3. Similarly, a forced initializing waveform is applied to scan electrode SCi+4 in the specific-cell initializing period of field Fj+3, but no forced initializing waveform is applied and a selective initializing waveform is applied to scan electrode SCi+3 and scan electrode SCi+5 that are adjacent to scan electrode SCi+4 in the specific-cell initializing periods of field Fj+3 and next field Fj+4. Similarly, a forced initializing waveform is applied to scan electrode SCi+2 in the specific-cell initializing period of field Fj+4, but no forced initializing waveform is applied and a selective initializing waveform is applied to scan electrode SCi+1 and scan electrode SCi+3 that are adjacent to scan electrode SCi+2 in the specific-cell initializing periods of field Fj+4 and next field Fj+5.

Thus, the temporal and spatial continuity of the discharge cell to undergo the forced initializing operation are reduced, so that the light emission by the forced initializing operation is hardly recognized by a user.

In the plasma display apparatus of the present exemplary embodiment, as discussed above, in the discharge cell having undergone a selective initializing operation in the specific-cell initializing period, the address time in the address period immediately after the specific-cell initializing period is made longer than that in the discharge cell having undergone a forced initializing operation in the specific-cell initializing period.

In the example of FIG. 5, the pulse width of the scan pulse occurring in the address period immediately after the specific-cell initializing period is set at T0 in the fields having “O”, and the pulse width of the scan pulse occurring in the address period immediately after the specific-cell initializing period is set at T1 in the fields having “x”. And, pulse width T1 is set to be greater than pulse width T0.

Thus, even in the discharge cell where initializing discharge does not occur in the specific-cell initializing period, the number of priming particles is relatively insufficient, and the discharge delay time of address discharge is relatively long, address discharge can be stably caused similarly to the discharge cell where initializing discharge occurs to make a sufficient number of priming particles remain.

Next, the configuration of the plasma display apparatus of the present exemplary embodiment is described.

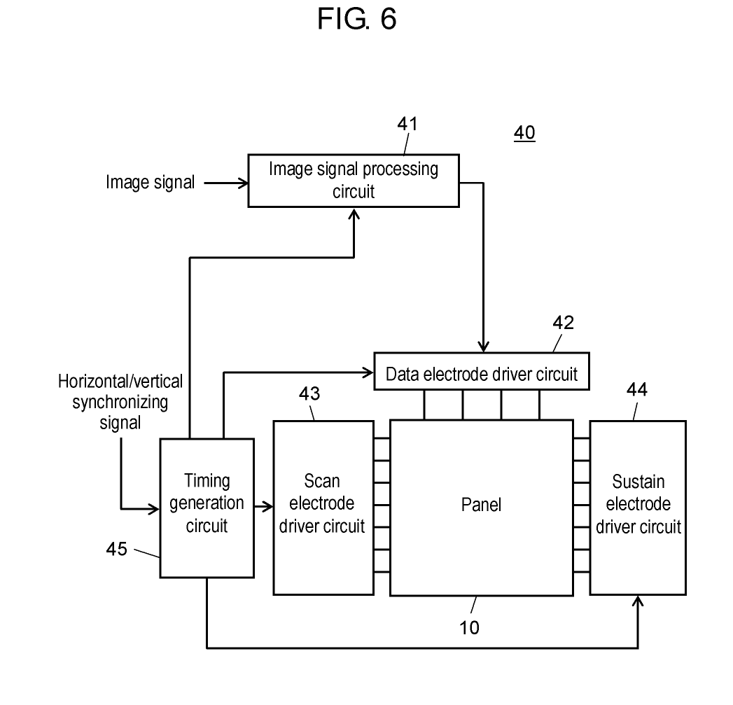

FIG. 6 is a diagram for schematically showing one example of circuit blocks constituting plasma display apparatus 40 in accordance with the first exemplary embodiment of the present invention.

Plasma display apparatus 40 includes panel 10 and a driving circuit for driving panel 10. The driving circuit includes the following elements:
image signal processing circuit 41;
data electrode driver circuit 42;
scan electrode driver circuit 43;
sustain electrode driver circuit 44;
timing generation circuit 45; and
a power supply circuit (not shown) for supplying power required for each circuit block.

The image signal input to image signal processing circuit 41 includes a red image signal, a green image signal, and a blue image signal. Image signal processing circuit 41 sets each gradation value (gradation value represented in one field) of red, green, and blue to each discharge cell based on the red image signal, green image signal, and blue image signal. When the input image signal includes a luminance signal (Y signal) and a chroma signal (C signal, R-Y signal and B-Y signal, or u signal and v signal), image signal processing circuit 41 calculates the red image signal, green image signal, and blue image signal based on the luminance signal and chroma signal, and then sets each gradation value of red, green, and blue to each discharge cell. Image signal processing circuit 41 converts each gradation value of red, green, and blue set to each discharge cell into image data (in this data, lighting and no-lighting correspond to “1” and “0” of a digital image) that indicates lighting or no lighting in each subfield. In other words, image signal processing circuit 41 converts the red image signal, green image signal, and blue image signal into red image data, green image data, and blue image data.

Timing generation circuit 45 generates various control signals for controlling the operation of respective circuit blocks based on a horizontal synchronizing signal and vertical synchronizing signal. Timing generation circuit 45 supplies the generated control signals to respective circuit blocks (data electrode driver circuit 42, scan electrode driver circuit 43, sustain electrode driver circuit 44, and image signal processing circuit 41).

Scan electrode driver circuit 43 has an initializing waveform generation circuit, a sustain pulse generation circuit, and a scan pulse generation circuit (not shown in FIG. 6). Scan electrode driver circuit 43 generates driving voltage waveforms based on a timing signal supplied from timing generation circuit 45, and applies them to scan electrode SC1 through scan electrode SCn, respectively. The initializing waveform generation circuit generates forced initializing waveforms and selective initializing waveforms applied to scan electrode SC1 through scan electrode SCn in the initializing period based on the timing signal. The sustain pulse generation circuit generates sustain pulses applied to scan electrode SC1 through scan electrode SCn in the sustain period based on the timing signal.

The scan pulse generation circuit has a plurality of scan electrode driver integrated circuits (scan ICs), and generates scan pulses applied to scan electrode SC1 through scan electrode SCn in the address period at a pulse width based on the timing signal. For example, in a field where a forced initializing waveform has been generated in the specific-cell initializing period, a scan pulse of pulse width T0 is generated in the address period immediately after the specific-cell initializing period. In a field where a selective initializing waveform has been generated in the specific-cell initializing period, a scan pulse of pulse width T1 greater than pulse width T0 is generated in the address period immediately after the specific-cell initializing period.

Sustain electrode driver circuit 44 has a sustain pulse generation circuit and a circuit (not shown in FIG. 6) for generating voltage Ve. Sustain electrode driver circuit 44 generates driving voltage waveforms based on a timing signal supplied from timing generation circuit 45, and applies them to sustain electrode SU1 through sustain electrode SUn, respectively. In the sustain period, sustain electrode driver circuit 44 generates sustain pulses based on the timing signal and applies them to sustain electrode SU1 through sustain electrode SUn, respectively. In the initializing period and address period, sustain electrode driver circuit 44 generates voltage Ve based on the timing signal and applies it to sustain electrode SU1 through sustain electrode SUn.

Data electrode driver circuit 42 generates address pulses corresponding to data electrode D1 through data electrode Dm based on the image data of each color output from image signal processing circuit 41 and the timing signal supplied from timing generation circuit 45. At this time, data electrode driver circuit 42 generates the address pulses at a pulse width based on the timing signal supplied from timing generation circuit 45. For example, in a field where a forced initializing waveform has been generated in the specific-cell initializing period, an address pulse of a pulse width equivalent to or greater than pulse width T0 is generated in the address period immediately after the specific-cell initializing period. In a field where a selective initializing waveform has been generated in the specific-cell initializing period, an address pulse of a pulse width equivalent to or greater than pulse width T1 is generated in the address period immediately after the specific-cell initializing period. Data electrode driver circuit 42 applies the address pulses to data electrode D1 through data electrode Dm in the address period, respectively.

Next, the details of scan electrode driver circuit 43 and the operation thereof are described.

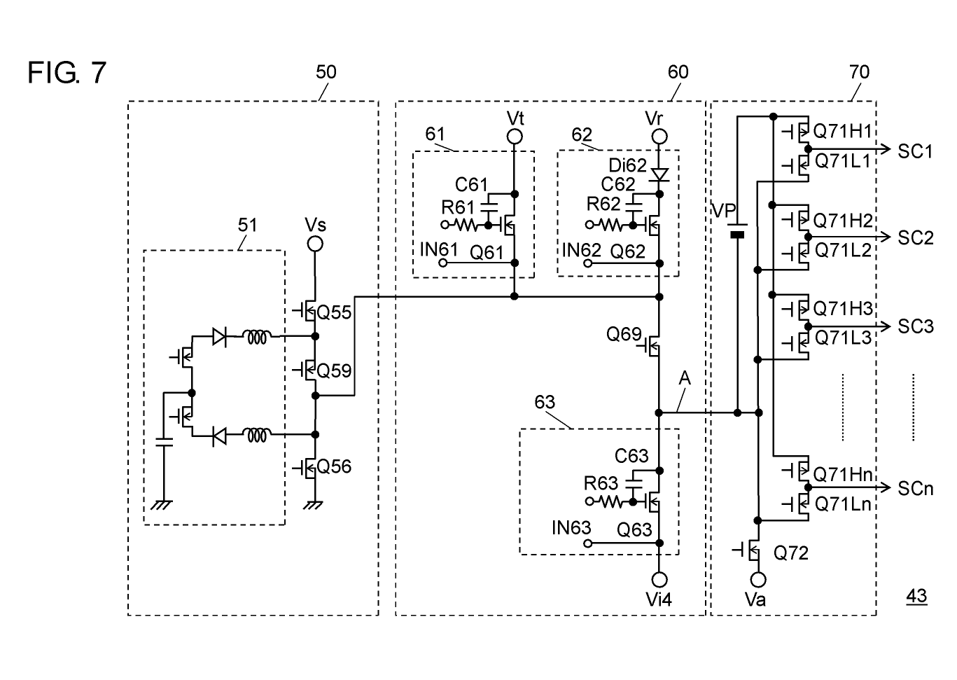

FIG. 7 is a circuit diagram for schematically showing one configuration example of scan electrode driver circuit 43 used for plasma display apparatus 40 in accordance with the first exemplary embodiment of the present invention. Scan electrode driver circuit 43 has sustain pulse generation circuit 50 for generating a sustain pulse, ramp waveform voltage generation circuit 60 for generating an initializing waveform, and scan pulse generation circuit 70 for generating a scan pulse. Each output terminal of scan pulse generation circuit 70 is connected to each of scan electrode SC1 through scan electrode SCn of panel 10.

In the present exemplary embodiment, the voltage input to scan pulse generation circuit 70 is denoted as “reference potential A”. In the following description, an operation of turning on a switching element is denoted as “ON”, and an operation of turning it off is denoted as “OFF”. A signal for setting the switching element at ON is denoted as “Hi”, and a signal for setting it at OFF is denoted as “Lo”. In FIG. 7, the details of the signal path of a control signal (timing signal supplied from timing generation circuit 45) input to each circuit are omitted.

Sustain pulse generation circuit 50 includes power recovery circuit 51 and a clamping circuit, and generates sustain pulses to be applied to scan electrode SC1 through scan electrode SCn.

Power recovery circuit 51 includes a capacitor for power recovery, a plurality of switching elements, a plurality of diodes for back flow prevention, and a plurality of inductors for resonance. The capacitor for power recovery has a capacity sufficiently large comparing with inter-electrode capacity Cp of panel 10, and is charged to about Vs/2, namely a half of voltage value Vs, so as to work as the power supply of power recovery circuit 51. Power recovery circuit 51 recovers the electric power accumulated in inter-electrode capacity Cp of panel 10 to the capacitor for power recovery using LC resonance, and reuses the electric power accumulated in the capacitor for power recovery for driving scan electrode SC1 through scan electrode SCn.

The clamping circuit has switching element Q55, switching element Q56, and switching element Q59. Switching element Q55 clamps scan electrode SC1 through scan electrode SCn on voltage Vs, and switching element Q56 clamps scan electrode SC1 through scan electrode SCn on voltage 0 (V). Switching element Q59 is a separation switch and is disposed for preventing current from flowing back via a parasitic diode or the like of a switching element constituting scan electrode driver circuit 43.

Sustain pulse generation circuit 50 generates a sustain pulse by switching the switching elements based on the timing signal output from timing generation circuit 45.

Ramp waveform voltage generation circuit 60 includes Miller integrating circuit 61, Miller integrating circuit 62, and Miller integrating circuit 63. In FIG. 7, the input terminal of Miller integrating circuit 61 is denoted as IN61, the input terminal of Miller integrating circuit 62 is denoted as IN62, and the input terminal of Miller integrating circuit 63 is denoted as IN63. Miller integrating circuit 61 and Miller integrating circuit 62 generate increasing ramp waveform voltage, and Miller integrating circuit 63 generates decreasing ramp waveform voltage.

Miller integrating circuit 61 has transistor Q61, capacitor C61, and resistor R61, and generates up-ramp waveform voltage that gently increases to voltage Vt. Miller integrating circuit 61, for example during an initializing operation, increases reference potential A of scan electrode driver circuit 43 to voltage Vi5 (for example, voltage Vi5 equals voltage Vt) gently in a ramp shape (for example, at about 1.3 V/μsec) to generate up-ramp voltage L1′.

Miller integrating circuit 62 has transistor Q62, capacitor C62, resistor R62, and diode Di62 for back flow prevention. At the end of the sustain period, Miller integrating circuit 62 increases reference potential A to voltage Vr at a gradient (for example, at about 10 V/μsec) steeper than that of up-ramp voltage L1′ to generate erasing ramp voltage L3.

Miller integrating circuit 63 has transistor Q63, capacitor C63, and resistor R63. During an initializing operation, Miller integrating circuit 63 decreases reference potential A to voltage Vi4 gently in a ramp shape (for example, at a gradient of −1.5 V/μsec) to generate down-ramp voltage L2 and down-ramp voltage L4.

Switching element Q69 of FIG. 7 is a separation switch and is disposed for preventing current from flowing back via a parasitic diode or the like of a switching element constituting scan electrode driver circuit 43. When Miller integrating circuit 63 using voltage Vi4 of negative polarity operates, for example, switching element Q69 electrically separates Miller integrating circuit 63 from sustain pulse generation circuit 50, Miller integrating circuit 61 using voltage Vt, and Miller integrating circuit 62 using voltage Vr.

Scan pulse generation circuit 70 has switching element Q71H1 through switching element Q71Hn, switching element Q71L1 through switching element Q71Ln, switching element Q72, and voltage source VP for applying scan pulses to n scan electrode SC1 through scan electrode SCn, respectively.

One terminal of switching element Q71Hj (j is 1 through n) is connected to one terminal of switching element Q71Lj, and the connection part serves as an output terminal of scan pulse generation circuit 70 and is connected to scan electrode SCj. The other terminals of switching element Q71H1 through switching element Q71Hn are connected to the high voltage side of voltage source VP, and the other terminals of switching element Q71L1 through switching element Q71Ln are connected to the low voltage side (reference potential A) of voltage source VP.

Switching element Q71H1 through switching element Q71Hn and switching element Q71L1 through switching element Q71Ln are classified into a plurality of outputs, and the outputs are integrated into ICs. These ICs are scan ICs.

Switching element Q72 connects reference potential A to voltage Va of negative polarity in the address period.

Voltage source VP generates voltage Vp and adds it to reference potential A. Therefore, the voltage on the high voltage side of voltage source VP is derived by adding voltage Vp to reference potential A, and the voltage on the low voltage side of voltage source VP is equal to reference potential A.

In scan pulse generation circuit 70 having such a configuration, in the address period, switching element Q72 is set at ON, reference potential A is made equal to voltage Va of negative polarity, voltage Va of negative polarity is applied to input terminals of switching element Q71L1 through switching element Q71Ln, and voltage Vc which is voltage Va+voltage Vp is applied to input terminals of switching element Q71H1 through switching element Q71Hn. To scan electrode SCi to which a scan pulse is to be applied, scan pulse voltage Va of negative polarity is applied via switching element Q71Li by setting switching element Q71Hi at OFF and setting switching element Q71Li at ON based on the image data. To scan electrode SCh (h is an integer of 1 through n except i) to which no scan pulse is to be applied, voltage Va+voltage Vp (=voltage Vc) is applied via switching element QHh by setting switching element Q71Lh at OFF and setting switching element Q71Hh at ON.

Scan pulse generation circuit 70 of the present exemplary embodiment controls ON and OFF of switching element Q71H1 through switching element Q71Hn and switching element Q71L1 through switching element Q71Ln based on a timing signal output from timing generation circuit 45. Thus, in the field in which a forced initializing waveform has been generated in the specific-cell initializing period, a scan pulse of pulse width T0 is generated in the address period immediately after the specific-cell initializing period. In the field in which a selective initializing waveform has been generated in the specific-cell initializing period, a scan pulse of pulse width T1 greater than pulse width T0 is generated in the address period immediately after the specific-cell initializing period.

Scan pulse generation circuit 70, in the specific-cell initializing period, sets switching element Q71Lx at OFF and sets switching element Q71Hx at ON for scan electrode SCx to which a forced initializing waveform is applied. Thus, up-ramp voltage L1 derived by adding voltage Vp to up-ramp voltage L1′ output from ramp waveform voltage generation circuit 60 is applied to scan electrode SCx via switching element Q71Lx. In the specific-cell initializing period, to scan electrode SCy to which a selective initializing waveform is to be applied, up-ramp voltage L1′ is applied via switching element Q71Ly by setting switching element Q71Hy at OFF and setting switching element Q71Ly at ON.

Scan pulse generation circuit 70, in the sustain period, sets switching element Q71H1 through switching element Q71Hn at OFF and sets switching element Q71L1 through switching element Q71Ln at ON, thereby outputting the output voltage of sustain pulse generation circuit 50 as it is and applying the voltage to scan electrode SC1 through scan electrode SCn.

Next, data electrode driver circuit 42 is described.

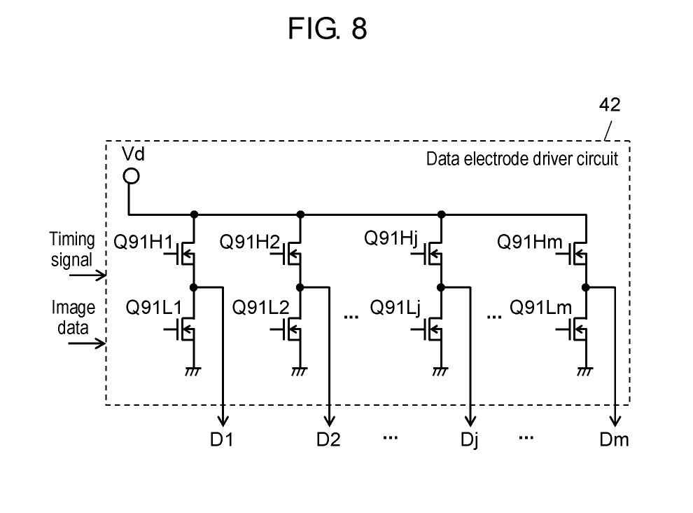

FIG. 8 is a circuit diagram for schematically showing one configuration example of data electrode driver circuit 42 used for plasma display apparatus 40 in accordance with the first exemplary embodiment of the present invention.

In FIG. 8, the details of the signal path of the control signal (timing signal supplied from timing generation circuit 45, and image data supplied from image signal processing circuit 41) input to each circuit are omitted.

Data electrode driver circuit 42 has switching element Q91H1 through switching element Q91Hm and switching element Q91L1 through switching element Q91Lm. When voltage 0 (V) is applied to data electrode Dj based on image data (the details of image data is not shown in FIG. 8) in the address period, data electrode driver circuit 42 sets switching element Q91Lj at ON and sets switching element Q91Hj at OFF. When voltage Vd is applied to data electrode Dj, data electrode driver circuit 42 sets switching element Q91Lj at OFF and sets switching element Q91Hj at ON.

Data electrode driver circuit 42 of the present exemplary embodiment controls ON and OFF of switching element Q91H1 through switching element Q91Hm and switching element Q91L1 through switching element Q91Lm based on a timing signal output from timing generation circuit 45. Thus, in the field in which a forced initializing waveform has been generated in the specific-cell initializing period, an address pulse of pulse width T0 or greater is generated in the address period immediately after the specific-cell initializing period. In the field in which a selective initializing waveform has been generated in the specific-cell initializing period, an address pulse of pulse width T1 or greater is generated in the address period immediately after the specific-cell initializing period.

These switching elements and transistors can be formed using a generally known element such as a metal oxide semiconductor field effect transistor (MOSFET) or an insulated gate bipolar transistor (IGBT). These switching elements and transistors are controlled in response to the timing signals that are generated by timing generation circuit 45 and correspond to the switching elements and transistors.

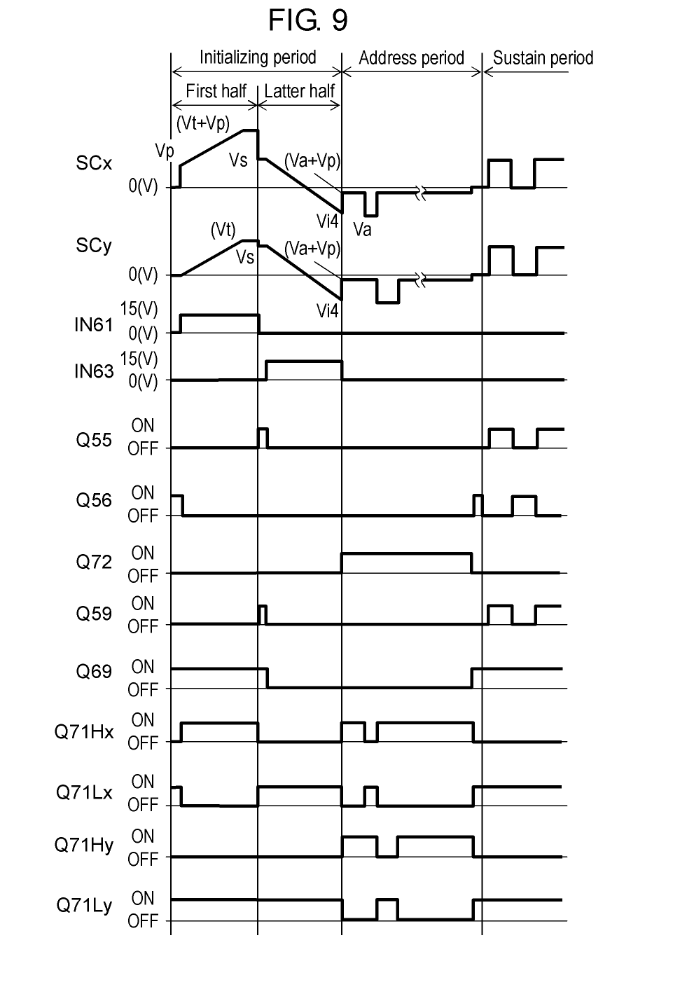

Next, the operation of scan electrode driver circuit 43 when a forced initializing waveform and non-initializing waveform are generated in the initializing period of the specific-cell initializing subfield and a scan pulse is generated in the address period of the specific-cell initializing subfield is described using FIG. 9.

FIG. 9 is a timing chart for illustrating one example of the operation of scan electrode driver circuit 43 in the initializing period and address period of the specific-cell initializing subfield in accordance with the first exemplary embodiment of the present invention. In FIG. 9, scan electrode 22 to which a forced initializing waveform is applied is referred to as “scan electrode SCx”, and scan electrode 22 to which not a forced initializing waveform but a selective initializing waveform is applied is referred to as “scan electrode SCy”.

In FIG. 9, of switching element Q71H1 through switching element Q71Hn, a switching element corresponding to scan electrode SCx is referred to as switching element Q71Hx, and a switching element corresponding to scan electrode SCy is referred to as switching element Q71Hy. Similarly, of switching element Q71L1 through switching element Q71Ln, a switching element corresponding to scan electrode SCx is referred to as switching element Q71Lx, and a switching element corresponding to scan electrode SCy is referred to as switching element Q71Ly.

In the following description, voltage Vi1 is set equal to voltage Vp, voltage Vi2 is set equal to voltage Vt+voltage Vp, voltage Vi3 is set equal to voltage Vs used when a sustain pulse is generated, voltage Vi5 is set equal to voltage Vt, and voltage Vc is set equal to voltage Va+voltage Vp.

FIG. 9 shows an example where voltage Vt is set at a voltage value higher than voltage Vs. However, voltage Vt and voltage Vs may have the same voltage value, or the voltage value of voltage Vs may be higher than that of voltage Vtc.

Hereinafter, the operation in the specific-cell initializing period and the operation in the address period are described in that order.

In the first half of the specific-cell initializing period, firstly, switching element Q56, switching element Q69, switching element Q71Lx, and switching element Q71Ly are set at ON, switching element Q55, switching element Q59, switching element Q72, switching element Q71Hx, and switching element Q71Hy are set at OFF, thereby applying voltage 0 (V) to scan electrode SCx and scan electrode SCy.

Next, switching element Q56 is set at OFF, switching element Q71Lx is set at OFF, and switching element Q71Hx is set at ON, thereby applying voltage Vp to scan electrode SCx to which a forced initializing waveform is applied. Switching element Q71Ly is kept at ON, switching element Q71Hy is kept at OFF, and the application of voltage 0 (V) to scan electrode SCy is kept.

Next, a predetermined voltage difference (e.g. 5 (V)) is applied between the terminals (in FIG. 7, two terminals represented as the input terminal of Miller integrating circuit 61) of input terminal IN61 of Miller integrating circuit 61 for generating up-ramp voltage L1′.

Thus, constant current flows toward capacitor C61, source voltage of transistor Q61 increases in a ramp shape, and reference potential A starts increasing from 0 (V) in a ramp shape. This voltage increase can be continued while the predetermined voltage difference is applied between the terminals of input terminal IN61 or until reference potential A arrives at voltage Vt.

Thus, up-ramp voltage L1′ that increases from 0 (V) to voltage Vi5 (equal to voltage Vt in the present exemplary embodiment) is generated.

Since switching element Q71Hy is at OFF and switching element Q71Ly is at ON, up-ramp voltage L1′ is applied to scan electrode SCy as it is.

While, since switching element Q71Hx is at ON and switching element Q71Lx is at OFF, the voltage derived by adding voltage V p to up-ramp voltage L1′ is applied to scan electrode SCx. The derived voltage is, namely, up-ramp voltage L1, which increases from voltage Vi1 (equal to voltage Vp in the present exemplary embodiment) to voltage Vi2 (equal to voltage Vt+voltage Vp in the present exemplary embodiment).

Immediately before entering the latter half of the specific-cell initializing period, the voltage difference between the terminals of input terminal IN61 is set at 0 (V). Thus, the operation of Miller integrating circuit 61 stops.

In the latter half of the specific-cell initializing period, switching element Q55 and switching element Q59 are set at ON to make reference potential A at voltage Vs. Switching element Q71H1 through switching element Q71Hn are set at OFF and switching element Q71L1 through switching element Q71Ln are set at ON, thereby applying reference potential A to scan electrode SC1 through scan electrode SCn. Thus, voltage Vi3 (equal to voltage Vs in the present exemplary embodiment) is applied to scan electrode SC1 through scan electrode SCn.

Next, switching element Q69 is set at OFF, and a predetermined voltage difference (e.g. 5 (V)) is applied between the terminals (in FIG. 7, two terminals represented as the input terminal of Miller integrating circuit 63) of input terminal IN63 of Miller integrating circuit 63 for generating down-ramp voltage L2.

Thus, constant current flows toward capacitor C63, drain voltage of transistor Q63 starts decreasing in a ramp shape, and the output voltage of scan electrode driver circuit 43 also starts decreasing to negative voltage Vi4 in a ramp shape. This voltage decrease can be continued while the predetermined voltage difference is applied between the terminals of input terminal IN63 or until reference potential A arrives at voltage Vi4.

After the output voltage of scan electrode driver circuit 43 arrives at negative voltage Vi4, the voltage difference between the terminals of input terminal IN63 is set at 0 (V). Thus, the operation of Miller integrating circuit 63 stops.

Thus, down-ramp voltage L2, which decreases from voltage Vi3 (equal to voltage Vs in the present exemplary embodiment) to voltage Vi4, is generated and applied to scan electrode SC1 through scan electrode SCn.

In the subsequent address period, switching element Q72 is set at ON to make reference potential A at voltage Va.

Furthermore, switching element Q71H1 through switching element Q71Hn are set at ON and switching element Q71L1 through switching element Q71Ln are set at OFF. Thus, voltage Vc (equal to voltage Va+voltage Vp in the present exemplary embodiment) derived by adding voltage Vp to reference potential A is applied to scan electrode SC1 through scan electrode SCn.

Next, switching element Q71H1 is set at OFF and switching element Q71L1 is set at ON, thereby applying voltage Va to scan electrode SC1. After a predetermined time, switching element Q71L1 is set at OFF and switching element Q71H1 is set at ON, thereby applying voltage Va+voltage Vp to scan electrode SC1. Thus, a scan pulse is applied to scan electrode SC1. Hereinafter, a similar operation is sequentially performed from scan electrode SC2 to scan electrode SCn, and scan pulses are applied to scan electrode SC1 through scan electrode SCn.

At this time, a scan pulse of pulse width T0 is applied to scan electrode SCx to which a forced initializing waveform has been applied. Specifically, the period is set at T0 which is after switching element Q71Hx is set at OFF and switching element Q71Lx is set at ON until switching element Q71Hx is returned to ON and switching element Q71Lx is returned to OFF. Thus, a scan pulse of pulse width T0 is generated and applied to scan electrode SCx.

A scan pulse of pulse width T1 is applied to scan electrode SCy to which not a forced initializing waveform but a selective initializing waveform has been applied. Specifically, the period is set at T1 which is after switching element Q71Hy is set at OFF and switching element Q71Ly is set at ON until switching element Q71Hy is returned to ON and switching element Q71Ly is returned to OFF. Thus, a scan pulse of pulse width T1 is generated and applied to scan electrode SCy.

After the completion of the address period, switching element Q72 and switching element Q71H1 through switching element Q71Hn are set at OFF, and switching element Q56, switching element Q69, and switching element Q71L1 through switching element Q71Ln are set at ON, thereby applying voltage 0 (V) to scan electrode SC1 through scan electrode SCn and preparing for the subsequent sustain period.

In the present exemplary embodiment, thus, in the initializing period of the specific-cell initializing subfield, a forced initializing waveform is generated and applied to scan electrode SCx and a selective initializing waveform is generated and applied to scan electrode SCy. In the address period of the specific-cell initializing subfield, a scan pulse of pulse width T0 is applied to scan electrode SCx to which the forced initializing waveform has been applied and a scan pulse of pulse width T1 is applied to scan electrode SCy to which the selective initializing waveform has been applied.

In the present exemplary embodiment, the configuration has been described where the forced initializing operation using a forced initializing waveform is performed once for five fields in each discharge cell. However, the present invention is not limited to this configuration. The frequency at which the forced initializing operation is performed in each discharge cell may be one or more for five fields, or may be less than one for five fields.

In the present exemplary embodiment, the number of subfields constituting one field and the luminance weight of each subfield are not limited to the above-mentioned numerical values. The subfield structure may be changed based on an image signal or the like.

### Second Exemplary Embodiment

In the first exemplary embodiment, the example has been described where scan electrode 22 to which a forced initializing waveform is to be applied is set based on (rule 1) and (rule 2), and, when the number of fields constituting one field group is five or larger, scan electrode 22 to which a forced initializing waveform is to be applied is set based on (rule 3) in addition to (rule 1) and (rule 2). In the present invention, however, scan electrode 22 to which a forced initializing waveform is to be applied is not limited to these rules. In the present exemplary embodiment, an example is described where scan electrode 22 to which a forced initializing waveform is to be applied is set based on a rule other than the rules of the first exemplary embodiment.

In the present exemplary embodiment, when a forced initializing operation is applied to one scan electrode 22 once for one of N temporally continuous fields (N is an integer), N temporally continuous fields are set as one field group. M continuously arranged scan electrodes 22 are set as one scan electrode group. It is assumed that M≦N.

Under this condition, scan electrode 22 to which a forced initializing waveform is to be applied is set based on the following rules.

(Rule 1) The number of fields to undergo a forced initializing operation in one scan electrode 22 is one in each field group.

(Rule 2′) The number of scan electrodes 22 to undergo a forced initializing operation in one field is one or zero in each scan electrode group.

When N is four or larger, namely when one field group is constituted by four or more fields, the following rule 3 is defined.

(Rule 3) To scan electrode SCx−1 and scan electrode SCx+1 that are adjacent to scan electrode SCx to which a forced initializing waveform is applied in the specific-cell initializing period of one field, no forced initializing waveform is applied and a selective initializing waveform is applied, at least in the specific-cell initializing periods of that field and the next field.

Thus, rule 1 of the second exemplary embodiment is the same as rule 1 of the first exemplary embodiment, but rule 2′ of the second exemplary embodiment is different from rule 2 of the first exemplary embodiment. The number of fields constituting one field group when rule 3 is applied differs between the second exemplary embodiment and the first exemplary embodiment.

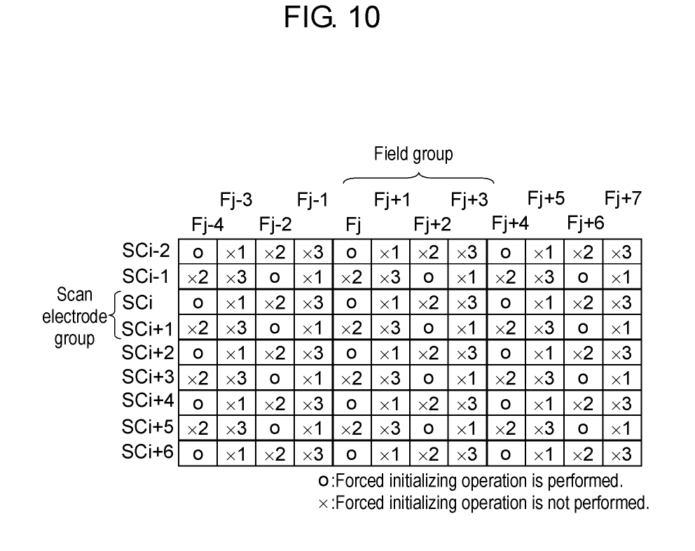

FIG. 10 is a diagram showing one example of a generation pattern of a forced initializing operation and selective initializing operation in accordance with the second exemplary embodiment of the present invention. In FIG. 10, the horizontal axis shows field and the vertical axis shows scan electrodes 22.

FIG. 10 shows one example when four temporally continuous fields are set as one field group and two sequentially disposed scan electrodes 22 are set as one scan electrode group. In the example of FIG. 10, one field group is constituted by field Fj, field Fj+1, field Fj+2, and field Fj+3 (N=4), and one scan electrode group is constituted by scan electrode SCi and scan electrode SCi+1 (M=2).

“O” of FIG. 10 shows that a forced initializing operation is performed in the initializing period of subfield SF1 (namely, a forced initializing operation is performed in the specific-cell initializing period). “×1”, “×2”, and “×3” show that no forced initializing operation is performed in the initializing period of subfield SF1 (namely, a selective initializing operation is performed in the specific-cell initializing period).

In the example of FIG. 10, field Fj is assumed to be a first field, field Fj+1 is assumed to be a second field, field Fj+2 is assumed to be a third field, and field Fj+3 is assumed to be a fourth field.

In the specific-cell initializing subfield (subfield SF1) of the first field (e.g. field Fj) and in the specific-cell initializing period, a forced initializing waveform for a forced initializing operation is applied to (1+2×N)-th scan electrode SC(1+2×N) (e.g. scan electrode SCi) from the top of panel 10. To (2+2×N)-th scan electrode SC(2+2×N) (e.g. scan electrode SCi+1) from the top of panel 10, not a forced initializing waveform but a selective initializing waveform for a selective initializing operation is applied.

In the specific-cell initializing subfield (subfield SF1) of the second field (e.g. field Fj+1), not a forced initializing waveform but a selective initializing waveform is applied to all scan electrode SC1 through scan electrode SCn.

In the specific-cell initializing subfield (subfield SF1) of the third field (e.g. field Fj+2) and in the specific-cell initializing period, a forced initializing waveform for a forced initializing operation is applied to (2+2×N)-th scan electrode SC(2+2×N) (e.g. scan electrode SCi+1) from the top of panel 10. To (1+2×N)-th scan electrode SC(1+2×N) (e.g. scan electrode SCi) from the top of panel 10, not a forced initializing waveform but a selective initializing waveform is applied.

In the specific-cell initializing subfield (subfield SF1) of the fourth field (e.g. field Fj+3), not a forced initializing waveform but a selective initializing waveform is applied to all scan electrode SC1 through scan electrode SCn.

Thus, in the present exemplary embodiment, the number of fields to undergo a forced initializing operation in one scan electrode 22 is one in each field group (rule 1).

Thus, the number of forced initializing operations is decreased to ¼ of that when the forced initializing operation is performed in all discharge cells in each field. Therefore, light emission caused by the forced initializing operation is also reduced to ¼. Correspondingly, the luminance of black level of the display image can be reduced and the contrast ratio of the display image can be improved.

In the present exemplary embodiment, the number of scan electrodes 22 to undergo a forced initializing operation in one field is one or zero in each scan electrode group (rule 2′).

Thus, scan electrodes 22 to undergo the forced initializing operation are dispersed in respective fields, so that flicker (screen fluctuates) can be reduced comparing with the case where scan electrodes 22 to undergo the forced initializing operation are concentrated to one field.

In the present exemplary embodiment, to scan electrode SCx−1 and scan electrode SCx+1 that are adjacent to scan electrode SCx to which a forced initializing waveform is applied in the specific-cell initializing period of one field, no forced initializing waveform is applied and a selective initializing waveform is applied, at least in the specific-cell initializing periods of that field and the next field (rule 3).

In the example of FIG. 10, a forced initializing waveform is applied to scan electrode SCi in the specific-cell initializing period of field Fj, but no forced initializing waveform is applied and a selective initializing waveform is applied to scan electrode SCi-1 and scan electrode SCi+1 that are adjacent to scan electrode SCi in the specific-cell initializing periods of field Fj and next field Fj+1. Similarly, a forced initializing waveform is applied to scan electrode SCi+1 in the specific-cell initializing period of field Fj+2, but no forced initializing waveform is applied and a selective initializing waveform is applied to scan electrode SCi and scan electrode SCi+2 that are adjacent to scan electrode SCi+1 in the specific-cell initializing periods of field Fj+2 and next field Fj+3.

Thus, the temporal and spatial continuity of the discharge cell to undergo the forced initializing operation are reduced, so that the light emission by the forced initializing operation is hardly recognized by a user.

In the plasma display apparatus of the present exemplary embodiment, similarly to the first exemplary embodiment, in the discharge cell having undergone a selective initializing operation in the specific-cell initializing period, the address time in the address period immediately after the specific-cell initializing period is made longer than that in the discharge cell having undergone a forced initializing operation in the specific-cell initializing period.

In the present exemplary embodiment, differently from the first exemplary embodiment, four address times are set and the address times are selected in response to a field. The four address times are address time T0, address time T1, address time T2, and address time T3. Address time T1 is set longer than address time T0, address time T2 is set longer than address time T1, and address time T3 is set longer than address time T2.

Specifically, in the first field that undergoes a forced initializing operation in the specific-cell initializing period, the address time is set at T0 in the address period immediately after the specific-cell initializing period. In the second field that undergoes a selective initializing operation in the specific-cell initializing period and comes next to the first field, the address time is set at T1 in the address period immediately after the specific-cell initializing period. In the third field that undergoes a selective initializing operation in the specific-cell initializing period and comes next to the second field, the address time is set at T2 in the address period immediately after the specific-cell initializing period. In the fourth field that undergoes a selective initializing operation in the specific-cell initializing period and comes next to the third field, the address time is set at T3 in the address period immediately after the specific-cell initializing period.

In FIG. 10, a field where the address time is set at T0 in the address period of the specific-cell initializing subfield has “O” in its column (namely, in this field, a forced initializing operation is performed in the specific-cell initializing period). A field where the address time is set at T1 in the address period of the specific-cell initializing subfield has “×1” in its column, a field where the address time is set at T2 in the address period of the specific-cell initializing subfield has “×2” in its column, and a field where the address time is set at T3 in the address period of the specific-cell initializing subfield has “×3” in its column.

Thus, in the present exemplary embodiment, the address time in the address period of the specific-cell initializing subfield is made longer in a subfield temporally more separated from the specific-cell initializing period having undergone a forced initializing operation.

As discussed in the first exemplary embodiment, strictly speaking, the pulse width of the scan pulse or that of the address pulse is different from the address time. In the present exemplary embodiment, however, similarly to the first exemplary embodiment, the pulse width of the address pulse is set to be at least equivalent to or greater than the pulse width of the scan pulse, and the address pulse is also applied to the discharge cell in the period in which the scan pulse is applied to the discharge cell. Therefore, the pulse width of the scan pulse is assumed to be equal to the address time.

In the example of FIG. 10, in the first field (having “O” in its column) that undergoes a forced initializing operation in the specific-cell initializing period, a scan pulse of pulse width T0 is generated to perform an address operation in the address period immediately after the specific-cell initializing period.

In the second field (having “×1” in its column) that undergoes a selective initializing operation in the specific-cell initializing period and comes next to the first field, a scan pulse of pulse width T1 is generated to perform an address operation in the address period immediately after the specific-cell initializing period.

In the third field (having “×2” in its column) that undergoes a selective initializing operation in the specific-cell initializing period and comes next to the second field, a scan pulse of pulse width T2 is generated to perform an address operation in the address period immediately after the specific-cell initializing period.

In the fourth field (having “×3” in its column) that undergoes a selective initializing operation in the specific-cell initializing period and comes next to the third field, a scan pulse of pulse width T3 is generated to perform an address operation in the address period immediately after the specific-cell initializing period.

As discussed above, priming particles generated by initializing discharge reduce with the passage of time. Therefore, as the elapsed time from the forced initializing operation becomes long, the number of priming particles reduces more significantly and the discharge delay time in the address operation becomes relatively long.

However, in the present exemplary embodiment, in each field group, the address time (namely, pulse width of scan pulse) in the address period of the specific-cell initializing subfield is made longer in a subfield temporally more separated from the specific-cell initializing period having undergone a forced initializing operation.

Thus, address discharge can be caused stably in a discharge cell where no initializing discharge occurs in the specific-cell initializing period, the number of priming particles relatively decreases, and the discharge delay time of the address discharge becomes relatively long.

In the present exemplary embodiment, for example, address time T0 is 1.0 μsec (pulse width T0 is 1.0 psec), address time T1 is 1.1 psec (pulse width T1 is 1.1 psec), address time T2 is 1.3 psec (pulse width T2 is 1.3 psec), and address time T3 is 1.6 psec (pulse width T3 is 1.6 psec). However, the address times of the present invention are not limited to the above-mentioned numerical values. Preferably, each address time is set optimally in response to the characteristics of the panel or the specification of the plasma display apparatus.

In the present exemplary embodiment, in the address period of selective initializing subfields (for example, subfield SF2 through subfield SF10), a scan pulse of a fixed pulse width is applied to all discharge cells similarly to the first exemplary embodiment. This pulse width is T0, for example.

In the present exemplary embodiment, the configuration has been described where a forced initializing operation by a forced initializing waveform is performed once for four fields in each discharge cell. However, the present invention is not limited to this configuration. The frequency of the forced initializing operation in each discharge cell may be one or more for four fields, or may be less than one for four fields.

The driving voltage waveforms of FIG. 4 and FIG. 9 are simply one example of the exemplary embodiments of the present invention, and the present invention is not limited to this driving voltage waveform.

The circuit configurations of FIG. 6, FIG. 7, and FIG. 8 are also simply one example of the exemplary embodiments of the present invention, and the present invention is not limited to these circuit configurations.

Each circuit block shown in the exemplary embodiments of the present invention may be configured as an electric circuit for performing each operation shown in the exemplary embodiments, or may be configured using a microcomputer or the like programmed so as to perform a similar operation.

In the exemplary embodiments of the present invention, an example where 10 subfields constitute one field has been described. In the present invention, however, the number of subfields constituting one field is not limited to the above-mentioned value. For example, when the number of subfields is increased, the number of gradations displayable on panel 10 can be further increased. When the number of subfields is decreased, the time required for driving panel 10 can be shortened.

In the exemplary embodiments of the present invention, an example has been described where a scan pulse of pulse width T0 is applied to all discharge cells in the address period of selective initializing subfields (for example, subfield SF2 through subfield SF10). However, the present invention is not limited to this configuration. Preferably, the scan pulse generated in the address period of the selective initializing subfield has an optimal pulse width in response to the characteristics of the panel or the specification of the plasma display apparatus.

In the exemplary embodiments of the present invention, an example where the specific-cell initializing subfield is assumed to be subfield SF1 has been described. However, the present invention is not limited to this configuration. The specific-cell initializing subfield may be a subfield other than subfield SF1.

In the exemplary embodiments of the present invention, an example where one pixel is formed of discharge cells of three colors, namely red, green, and blue, has been described. However, also in a panel where one pixel is formed of discharge cells of four or more colors, the configurations shown in the exemplary embodiments of the present invention can be applied and a similar effect can be produced.

Each specific numerical value shown in the exemplary embodiments of the present invention is set based on the characteristics of panel 10 having a screen size of 50 inches and having 1024 display electrode pairs 24, and is simply one example in the exemplary embodiments. The present invention is not limited to these numerical values. Numerical values are preferably set optimally in response to the specification or characteristics of the panel or the specification of the plasma display apparatus. These numerical values can vary in a range allowing the above-mentioned effect. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

The present invention can improve the image display quality of a plasma display apparatus by sharpening the contract of a display image and stably causing the address discharge. Therefore, the present invention is useful as a driving method of a plasma display panel and as a plasma display apparatus.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35, 35R, 35G, 35B phosphor layer
40 plasma display apparatus
41 image signal processing circuit
42 data electrode driver circuit
43 scan electrode driver circuit
44 sustain electrode driver circuit
45 timing generation circuit
50 sustain pulse generation circuit
51 power recovery circuit
60 ramp waveform voltage generation circuit
61, 62, 63 Miller integrating circuit
70 scan pulse generation circuit
Q55, Q56, Q59, Q69, Q72, Q71H1 through Q71Hn, Q71L1 through Q71Ln, Q91H1 through Q91Hm, Q91L1 through Q91Lm switching element
IN61, IN62, IN63 input terminal
Q61, Q62, Q63 transistor
C61, C62, C63 capacitor
R61, R62, R63 resistor
Di62 diode
VP voltage source
L1, L1′ up-ramp voltage
L2, L4 down-ramp voltage
L3 erasing ramp voltage

1. A driving method for a plasma display panel, the driving method comprising:
displaying gradation on the plasma display panel having a plurality of discharge cells that has a data electrode and a display electrode pair formed of a scan electrode and a sustain electrode by setting a plurality of subfields having an initializing period, an address period, and a sustain period in one field,
wherein one of a forced initializing operation and a selective initializing operation is performed in the initializing period, the forced initializing operation causing initializing discharge in the discharge cells, the selective initializing operation selectively causing initializing discharge in the discharge cells having an address discharge in the immediately preceding subfield,
wherein, in an address period of a specific-cell initializing subfield having an initializing period in which the forced initializing operation is performed in specific discharge cells and the selective initializing operation is performed in the other discharge cells, a period in which a scan pulse and an address pulse are simultaneously applied to a discharge cell having undergone the selective initializing operation in the initializing period is longer than a period in which the scan pulse and the address pulse are simultaneously applied to a discharge cell having undergone the forced initializing operation, and
wherein, in a field having the specific-cell initializing subfield, the discharge cell having no address discharge in an address period in the specific-cell initializing subfield occurs no address discharge also in the address period in the subfields after the specific-cell initializing subfield.

2. The driving method for the plasma display panel of claim 1, wherein
one field group is constituted by a plurality of temporally continuous fields, and one scan electrode group is constituted by a plurality of sequentially disposed scan electrodes,
a forced initializing waveform for the forced initializing operation is applied to each of the scan electrodes constituting the scan electrode group only in one field of the one field group, and
in the address period of the specific-cell initializing subfield, the period in which the scan pulse and the address pulse are simultaneously applied to a discharge cell is made longer in a subfield temporally more away from the initializing period having undergone the forced initializing operation.

3. The driving method for the plasma display panel of claim 1, wherein
in the address period, a pulse width of the address pulse is set to be equivalent to or greater than a pulse width of the scan pulse, and the address pulse is also applied to a discharge cell to cause address discharge while the scan pulse is applied to the discharge cell, and
in the address period of the specific-cell initializing subfield, a pulse width of a scan pulse applied to a discharge cell having undergone the selective initializing operation in the initializing period of the specific-cell initializing subfield is greater than a pulse width of a scan pulse applied to a discharge cell having undergone the forced initializing operation in the initializing period of the specific-cell initializing subfield.

4. The driving method for the plasma display panel of claim 1, wherein
in the address period, a pulse width of the scan pulse is set to be equivalent to or greater than a pulse width of the address pulse, and the scan pulse is also applied to a discharge cell to cause address discharge while the address pulse is applied to the discharge cell, and
in the address period of the specific-cell initializing subfield, a pulse width of an address pulse applied to a discharge cell having undergone the selective initializing operation in the initializing period of the specific-cell initializing subfield is greater than a pulse width of an address pulse applied to a discharge cell having undergone the forced initializing operation in the initializing period of the specific-cell initializing subfield.

5. A plasma display apparatus comprising:
a plasma display panel having a plurality of discharge cells that has a data electrode and a display electrode pair formed of a scan electrode and a sustain electrode; and
a driving circuit that displays gradation on the plasma display panel by setting a plurality of subfields having an initializing period, an address period, and a sustain period in one field,
wherein the driving circuit performs one of a forced initializing operation of causing initializing discharge in the discharge cells and a selective initializing operation of selectively causing initializing discharge in the discharge cells having an address discharge in the immediately preceding subfield,
wherein, in an address period of a specific-cell initializing subfield having an initializing period in which the forced initializing operation is performed in specific discharge cells and the selective initializing operation is performed in the other discharge cells, the driving circuit makes a period in which a scan pulse and an address pulse being simultaneously applied to a discharge cell having undergone the selective initializing operation longer than a period in which the scan pulse and the address pulse being simultaneously applied to a discharge cell having undergone the forced initializing operation, and
wherein, in a field having the specific-cell initializing subfield, in the discharge cell having no address discharge in an address period in the specific-cell initializing subfield, the driving circuit performs no address discharge also in the address period in the subfields after the specific-cell initializing subfield.

6. The plasma display apparatus of claim 5, wherein
the driving circuit forms one field group using a plurality of temporally continuous fields, and forms one scan electrode group using a plurality of sequentially disposed scan electrodes,
the driving circuit applies a forced initializing waveform for the forced initializing operation to each of the scan electrodes constituting the scan electrode group only in one field of the one field group, and
in the address period of the specific-cell initializing subfield, the driving circuit makes the period in which the scan pulse and the address pulse are simultaneously applied to a discharge cell longer in a subfield temporally more away from the initializing period having undergone the forced initializing operation.

7. The plasma display apparatus of claim 5, wherein
in the address period, the driving circuit sets a pulse width of the address pulse to be equivalent to or greater than a pulse width of the scan pulse, and also applies the address pulse to a discharge cell to cause address discharge while the scan pulse is applied to the discharge cell, and
in the address period of the specific-cell initializing subfield, the driving circuit applies a scan pulse to a discharge cell having undergone the selective initializing operation in the initializing period of the specific-cell initializing subfield, a pulse width of the scan pulse being greater than a pulse width of a scan pulse that is applied to a discharge cell having undergone the forced initializing operation in the initializing period of the specific-cell initializing subfield.

8. The plasma display apparatus of claim 5, wherein
in the address period, the driving circuit sets a pulse width of the scan pulse to be equivalent to or greater than a pulse width of the address pulse, and also applies the scan pulse to a discharge cell to cause address discharge while the address pulse is applied to the discharge cell, and
in the address period of the specific-cell initializing subfield, the driving circuit applies an address pulse to a discharge cell having undergone the selective initializing operation in the initializing period of the specific-cell initializing subfield, a pulse width of the address pulse being greater than a pulse width of an address pulse that is applied to a discharge cell having undergone the forced initializing operation in the initializing period of the specific-cell initializing subfield.
